(19) United States
(12) Patent Application Publication
(10) Pub. No.: US 2022/0227546 A1
(43) Pub. Date: Jul. 21, 2022

(54) Paper Lid and Method for Producing Paper Lid

(71) Applicant: Kikuo Yamada, Tokyo (JP)

(72) Inventor: Kikuo Yamada, Tokyo (JP)

(21) Appl. No.: 17/569,209

(22) Filed: Jan. 5, 2022

Related U.S. Application Data
(63) Continuation of application No. 17/291,871, filed on May 6, 2021.
(60) Provisional application No. 62/797,397, filed on Jan. 28, 2019.
(60) Provisional application No. 62/796,617, filed on Jan. 25, 2019.
(60) Provisional application No. 62/793,943, filed on Jan. 18, 2019.
(60) Provisional application No. 62/790,050, filed on Jan. 9, 2019.
(60) Provisional application No. 62/786,567, filed on Dec. 31, 2018.
(60) Provisional application No. 62/785,763, filed on Dec. 28, 2018.
(60) Provisional application No. 62/784,863, filed on Dec. 26, 2018.
(60) Provisional application No. 62/781,026, filed on Dec. 18, 2018.
(60) Provisional application No. 62/779,530, filed on Dec. 14, 2018.
(60) Provisional application No. 62/775,935, filed on Dec. 6, 2018.
(60) Provisional application No. 62/774,355, filed on Dec. 3, 2018.
(60) Provisional application No. 62/772,649, filed on Nov. 29, 2018.
(60) Provisional application No. 62/770,852, filed on Nov. 23, 2018.
(60) Provisional application No. 62/768,142, filed on Nov. 16, 2018.

(30) Foreign Application Priority Data
Dec. 3, 2018 (JP) 2018-226847
Jan. 11, 2019 (JP) 2019-003320

(51) Int. Cl. B65D 47/06

(52) U.S. Cl. CPC B65D 47/06; B65D 2543/00046; B65D 2543/00092; B65D 2543/00268

(57) ABSTRACT

A paper lid for a container includes a body portion, a top lid portion having an outer periphery surrounded by the body portion, and an engaging portion in the body portion that includes a tapered portion tapering in the same direction as the container taper and engages with the container curl portion. The body portion has a first end portion for mounting on the container and an opposite second end portion. The outer periphery is bent toward the first end portion, and has a bent portion bonded to the body portion. A part other than the outer periphery is between the engaging portion and the second end portion. An inner diameter of a tip of the tapered portion is smaller than an outer diameter of the container curl portion. Where the lid closes the container opening, the container curl portion contacts an inner part of the tapered portion.

### CROSS-REFERENCE TO RELATED APPLICATION

This application is a continuation of U.S. patent application Ser. No. 17/291,871, filed May 6, 2021, which is incorporated herein in its entirety by reference.

### TECHNICAL FIELD

The present invention relates to a paper lid and a method for producing a paper lid, and particularly to a paper lid that is suitable for a liquid container and a method for producing the same.

### BACKGROUND ART

A paper cup is used as a container for various drinks such as coffee and tea. The paper cup is covered with a lid such that a liquid which is a content does not leak from the paper cup. In many cases, a plastic lid is used as the lid and does not match the recent trend that the use of plastics is reduced and an environmentally friendly product is used. In addition, a technique where a bottom part of a paper cup is used as a paper lid has been also proposed; however, the usability has not been taken into consideration (Japan Patent Application Publication No. 2006-248530).

### BRIEF SUMMARY

According to Japan Patent Application Publication No. 2006-248530, the taper of the paper cup and the taper of the lid are tapered forward and there is a risk of a leakage of the content when the paper cup is inclined, and thus the usability is not sufficient. In addition, a mere proposal of the paper lid has been made and details have not been studied, and thus the usability has not been sufficient.

An object of the present invention is to provide a paper lid with good usability.

According to an implementation of the teachings herein, there is provided a paper lid including a lid body portion that includes a paper material to be mounted on a container including an opening portion, a taper, and a curl portion; a first engaging portion that is provided in the lid body portion, includes a taper in the same direction as a direction of the taper, and engages with the curl portion from outside the curl portion; and a body portion side curl portion that is provided in the lid body portion and is positioned above the first engaging portion.

According to another implementation of the teachings herein, there is provided a method for producing a paper lid, the method including providing a drinking spout portion in a top lid portion using a paper material and a seal portion to be joined to the top lid portion and the drinking spout portion; and joining the top lid portion, in which the drinking spout portion and the seal portion are formed, to a tapered portion that has a tapered shape and uses a paper material.

According to yet another implementation of the teachings herein, there is provided a method for producing a paper lid to be mounted on a container including an opening portion, a taper, and a curl portion, the method including forming an engaging portion, which deforms the curl portion to engage with the curl portion, using a paper material having a fan shape; and joining a top lid portion to the engaging portion.

According to yet another implementation of the teachings herein, there is provided a paper lid including a body portion that includes a paper material; and an engaging portion that has an angle different from an angle of a taper and engages with the taper to be mounted on a container including an opening portion and the taper.

According to yet another implementation of the teachings herein, there is provided a paper lid including a body portion that includes a paper material and includes a first engaging portion which is engageable from outside an opening portion to be mounted on a container including the opening portion and a taper; and a second engaging portion that includes a paper material and is engageable from inside the opening portion.

In a paper lid described herein, the sealability of the paper lid is improved; and thereby, it is possible to improve the usability of the paper lid.

According to a method for producing a paper lid described herein, where the top lid portion where the drinking spout portion and the seal portion are formed is joined to the tapered portion that has a tapered shape and uses a paper material, it is possible to produce the paper lid with good usability.

According to a method for producing a paper lid described herein, where the engaging portion is formed to deform the curl portion of the container, the sealability of the paper lid is improved; and thereby, it is possible to improve the usability of the paper lid.

### BRIEF DESCRIPTION OF THE DRAWINGS

FIGS. 1A and 1B are cross-sectional views of a paper lid and a container of a first embodiment.

FIGS. 2A-2D are schematic views of the paper lid of the first embodiment.

FIG. 3 is a reference view illustrating a plastic lid.

FIGS. 4A and 4B are cross-sectional views of a paper lid and a container of a second embodiment.

FIGS. 5A-5C are schematic views of a paper lid with a holder of a third embodiment.

FIGS. 6A-6C are schematic views of a paper lid with a holder of a fourth embodiment.

FIG. 7 illustrates an example where the paper lid is provided with a handgrip and a holder.

FIGS. 8A-8E are schematic views of a paper lid of a fifth embodiment.

FIGS. 9A-9D are schematic views of a paper lid of a sixth embodiment.

FIGS. 10A-10C are views illustrating a method for producing the paper lid of the sixth embodiment.

FIG. 11 is a view illustrating the method for producing the paper lid of the sixth embodiment.

FIGS. 12A and 12B are views illustrating another method for producing the paper lid.

FIGS. 13A-13D are views illustrating an example of the fitting of a curl portion.

FIGS. 14A and 14B are cross-sectional views illustrating a modification example of a seal portion.

FIG. 15 is a cross-sectional view illustrating a modification example of the seal portion.

FIGS. 16A-16C are schematic views of a paper lid of a seventh embodiment.

FIGS. 17A and 17B are cross-sectional views of the paper lid of the seventh embodiment.

FIGS. 18A-18C are views illustrating an example of the joining of a top lid portion and an engaging portion.

FIGS. 19A-19F show a modification example of the paper lid of the sixth embodiment.

FIGS. 20A and 20B are enlarged cross-sectional views of a window portion of the seventh embodiment.

FIGS. 21A and 21B show a modification example of the window portion of the paper lid of the seventh embodiment.

FIGS. 22A-22G are cross-sectional views of a paper lid of an eighth embodiment.

FIGS. 23A-23C are cross-sectional views illustrating a seal portion of the paper lid of the eighth embodiment.

FIG. 24 is a schematic view and a cross-sectional view illustrating one example of an engaging portion of FIG. 22F.

FIG. 25A is a schematic view, a partial enlarged view, and an A-A cross-sectional view illustrating a display portion of a paper lid, and FIG. 25B is a schematic view illustrating an example where three display portions are provided without gaps therebetween and a front view of the paper lid.

FIG. 26 is a development view of the paper lid excluding a top lid portion.

FIGS. 27A-27E are cross-sectional views of the paper lid of the eighth embodiment.

FIG. 28 is a flowchart illustrating one example of a method for producing a paper lid.

FIG. 29 is a schematic view of the method for producing a paper lid.

FIGS. 30A and 30B are views illustrating a method for extracting a top lid portion from a raw material.

FIGS. 31A-31C are cross-sectional views of a forming device that forms a protruding portion.

FIGS. 32A and 32B are views illustrating a modification example.

### DETAILED DESCRIPTION

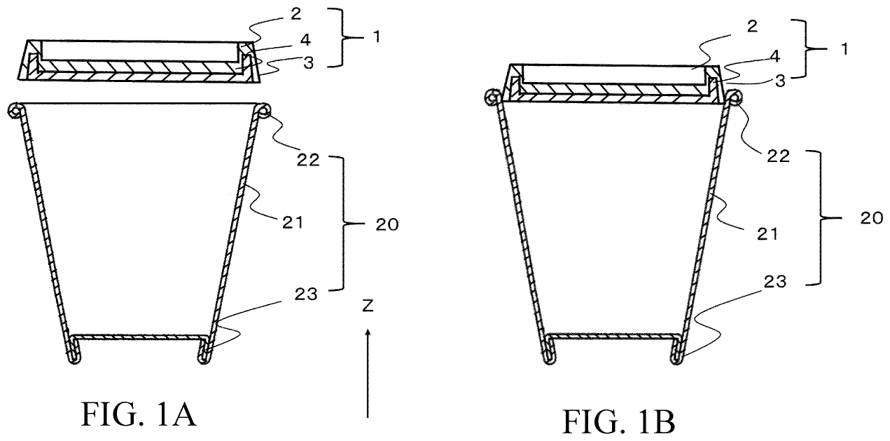

Hereinafter, embodiments of the present invention will be described with reference to FIGS. 1A to 32B. However, in the embodiments, the same reference sign will be assigned to a configuration having the same function, and duplicate descriptions will be omitted or simplified.

### First Embodiment

FIGS. 1A and 1B are cross-sectional views of a paper lid 1 and a container 20 of a first embodiment. FIG. 1A is a cross-sectional view illustrating a state where the paper lid 1 is removed from the container 20, and FIG. 1B is a cross-sectional view illustrating a state where the paper lid 1 is fitted to the container 20.

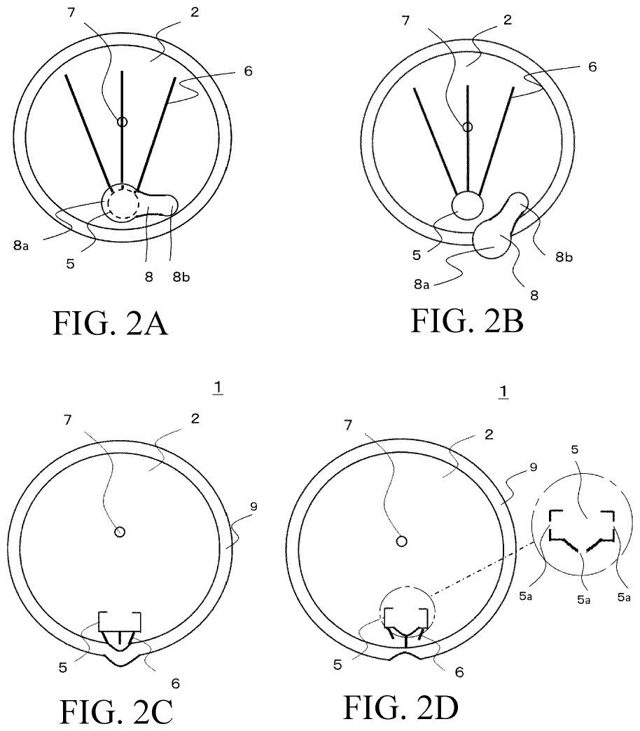

FIGS. 2A-2D are schematic views of the paper lid 1 of the first embodiment as seen from above. FIG. 2A illustrates a state where a seal portion 8 seals a drinking spout 5, and FIG. 2B is a view illustrating a mode where the seal portion 8 is removed from the drinking spout 5. In addition, FIGS. 2C and 2D illustrate a configuration where the drinking spout 5 is formed by bending toward a center of the paper lid 1, and a cut is indicated by a solid line.

Paper Lid

The paper lid 1 includes a top lid portion 2, a tapered portion 3 formed in the top lid portion 2, a bottom lid portion 4, the drinking spout 5, a groove portion 6, an air hole portion 7, and the seal portion 8.

The paper lid 1 is inserted inside the container 20 and is made of a paper material. The paper material may contain at least a cellulose component, and the content of the cellulose component is not specifically limited. In addition, a paper material formed by papermaking may be used.

In addition, as the paper material, various waterproof papers such as a coated paper of which the surface is provided with a coating layer may be used, or a coating layer may be provided at least on a container side surface of the paper material. A film or a coating agent can be used as the coating layer. As the film and the coating agent, it is possible to use polystyrene, polyethylene, polypropylene, polyethylene terephthalate, polyurethane, polyvinyl chloride, polyvinylidene chloride, polyvinyl acetate, cyanoacrylate, epoxy resin, polyacrylic resin, polymethacrylic resin, nylon, polycarbonate; biodegradable resins or biodegradable resin mixtures such as polycaprolactone, polyhydroxyalkanoate, polyhydroxybutyrate, polylactic acid, and starch-based resin such as esterified starch, cellulose acetate, polyethylene succinate, polyvinyl alcohol, polyglycolic acid, chitosan/cellulose/starch, poly(hydroxybutyrate/hydroxyhexanoate), poly(caprolactone/butylene succinate), polybutylene succinate, poly(butylene succinate/adipate), poly(butylene succinate/carbonate), poly(ethylene terephthalate/succinate), poly(butylene adipate/terephthalate), and poly(tetramethylene adipate/terephthalate); biodegradable biomass resins, fluororesins; silicone resin; ultraviolet curable resin; copolymers of monomer such as ethylene-vinyl acetate copolymer, ethylene-vinyl alcohol copolymer, ethylene-propylene copolymer, ethylene-propylene-butadiene copolymer, acrylic-styrene copolymer, styrene-butadiene copolymer, acrylonitrile-butadiene-styrene copolymer which form the foregoing resins; natural resin; paraffin, gelatin; cellophane; and polymethylpentene. The coating layer can be formed by applying or spraying films, emulsions, or solutions made of the foregoing resins, or coating agents such as a fluorine-based coating agent, a silicon-based coating agent, and a varnish.

The film may be a single layer film or a multilayer film, and not only one type of coating agent may be applied but also two or more types of coating agents may be repeatedly applied. It is desirable that a film made of a biodegradable resin such as a polylactic acid or a biodegradable resin mixture is used as the film or the coating agent, and in this manner, it is possible to reduce the environmental load. Even in a case where the material contains terephthalate such as poly (tetramethylene adipate/terephthalate), when the content is approximately 40%, the material has biodegradability.

In addition, when a coating agent is used, for example, a vegetable starch that does not adversely affect the human body may be used. In the present embodiment, a bottom part of a paper cup can be also used as the paper lid 1.

A step (sunken portion) having a depth of approximately 3 mm to 12 mm toward a lower side (container 20 side) is formed in the top lid portion 2, and the tapered portion 3 is formed in a side surface of the top lid portion 2. The tapered portion 3 is a taper (reverse taper) of which the taper direction is reverse to that of a tapered portion 21 of the exterior of the container 20 to be described, and has a tapered shape that is widened toward the container 20. The dimension of the tapered portion 3 in a height direction (Z direction in FIG. 1A) is larger than the dimension of a curl portion 22 to be described later of the container 20 in the height direction. Accordingly, when the paper lid 1 is inserted inside the container 20, even in a case where the container 20 is overturned, it is possible to reduce the risk of spilling the content of the container 20.

When the tapered portion 3 and the tapered portion 21 are tapered reversely to each other, because a fitting force functions in surface contact but in point contact (line contact), the fitting force is exerted on a fitting portion in a more concentrated manner compared to the case of surface contact. For this reason, the fittability of the tapered portion 3 and the tapered portion 21 is improved, and thus the sealability of the paper lid 1 is improved. In addition, because the tapered portion 3 and the tapered portion 21 are made of a paper material, the tapered portion 3 and the tapered portion 21 are deformed due to fitting, to form a slight planar portion. The planar portion improves the fittability of the tapered portion 3 and the tapered portion 21. In addition, even where the tapered portion 3 has a linear shape without a taper, it is possible to obtain the foregoing effect. Namely, the inclination of the tapered portion 3 may be different from the inclination of the tapered portion 21.

Incidentally, in order to improve the sealability of the paper lid 1, the tapered portion 3 may be provided with an irregular uneven portion or a step portion.

The bottom lid portion 4 is shaped to engage with the top lid portion 2. Various methods such as press working, ultrasonic joining, heat sealing, and an adhesive (for example, a starch paste) can be used to realize the engagement between the bottom lid portion 4 and the top lid portion 2.

The drinking spout 5 is an opening provided in the top lid portion 2 and the bottom lid portion 4, to serve as a drinking spout or a hole into which a straw is inserted, and the size or the shape thereof can be appropriately set. In addition, a cut line with a half-cut may be provided, and a user may remove the half-cut.

As illustrated in FIGS. 2C and 2D, the drinking spout 5 includes the cut indicated by the solid line, and a part where no cut is formed. The part where no cut is formed serves as a hinge. The drinking spout 5 is opened by bending the cut indicated by the solid line toward the center of the paper lid 1. In this case, the cut is provided in the top lid portion 2 and the bottom lid portion 4 is provided with an opening portion corresponding to the cut, so that the drinking spout 5 can be easily bent. In addition, the cut line is cut from a top lid portion 2 side toward the bottom lid portion 4. Where the cut line forms a V-shape (inverted triangular shape), in a state where the drinking spout 5 is closed, the content is less likely to leak from the container 20 to the top lid portion 2 side. The shape of the drinking spout 5 may be a linear shape, a curved shape, or a shape where a curved shape is added to a linear shape, or as illustrated in FIG. 2D, the drinking spout 5 may be shaped such that a pull-up portion is formed.

Where a curl portion 9 is widened outward as illustrated in FIG. 2C or an outer ring of the curl portion 9 is collapsed inward as illustrated in FIG. 2D to correspond to the drinking spout 5, the content is easily drunken from the drinking spout 5. Instead of the outer ring of the curl portion 9 in FIG. 2D, an inner ring thereof may be collapsed outward. In addition, as illustrated in a partial enlarged view of FIG. 2D, a connected portion 5a where no cut is formed may be provided in a part of a cut portion, which is indicated by the solid line, in the drinking spout 5. When the connected portion 5a is present, it is possible to recognize that the drinking spout 5 is not open. To the contrary, when the connected portion 5a is not present, it is possible to recognize that the drinking spout 5 is open. In relation to this, the connected portion 5a allows the user to recognize whether or not the openness of the drinking spout 5 is false. The formation positions or the number of the connected portions 5a can be randomly set. The connected portion 5a can be formed also in the drinking spout 5 in FIGS. 2A-2C.

As illustrated in FIGS. 2A and 2B, the groove portion 6 is a streak that is provided in the top lid portion 2, for example, by press working, and does not penetrate through the top lid portion 2. In the present embodiment, a plurality of the groove portions 6 are provided and connected to the drinking spout 5. When the content of the container 20 has accumulated from the drinking spout 5 to the sunken portion (step portion) of the top lid portion 2, the groove portions 6 guide the content, which has accumulated in the sunken portion of the top lid portion 2, to the drinking spout 5 to return the content to the container 20.

In addition, because the groove portions 6 are provided by press working, it is possible to improve the strength of the top lid portion 2 or the paper lid 1.

As illustrated in FIGS. 2C and 2D, the groove portions 6 may be provided from the drinking spout 5 toward the curl portion 9. In addition, the groove portions 6 may be formed to reach an edge portion, or may be formed up to a place immediately before the edge portion. The groove portions 6 illustrated in FIGS. 2C and 2D are capable of guiding the content from the drinking spout 5 to the mouth of the user. When the user separates their mouth from the drinking spout 5, the groove portions 6 are capable of returning the content, which remains in the vicinity of the drinking spout 5, to the drinking spout 5. FIGS. 2C and 2D illustrate three groove portions 6; however, the number of the groove portions 6 may be any number, and the groove portions 6 can be omitted. Instead of the groove portions 6 or in conjunction with the groove portions 6, where the foregoing coating layer is provided on a drinking spout 5 side of the top lid portion 2, it is possible to inhibit the content from spreading out on the top lid portion 2 after the content is ingested from the drinking spout 5. Furthermore, where the shape of the drinking spout 5 is, as illustrated in FIG. 2D, a shape where a part of the drinking spout 5 protrudes toward a peripheral edge of the top lid portion 2, it is possible to inhibit the content from spreading out on the top lid portion 2.

A sticker indicating the content may be affixed or printed on the top lid portion 2, and a sticker of the face of a human or an animal may be affixed or printed. In this case, where the drinking spout 5 is provided to correspond to the mouth of a human or the mouth of an animal, the user can enjoy the pleasure of kissing when the user ingests the content. In addition, a half of a face may be printed on the tapered portion 3 and the remaining part of the face may be printed on the tapered portion 21 of the container 20. Thereby, when the paper lid 1 is correctly mounted, the printed face is visible.

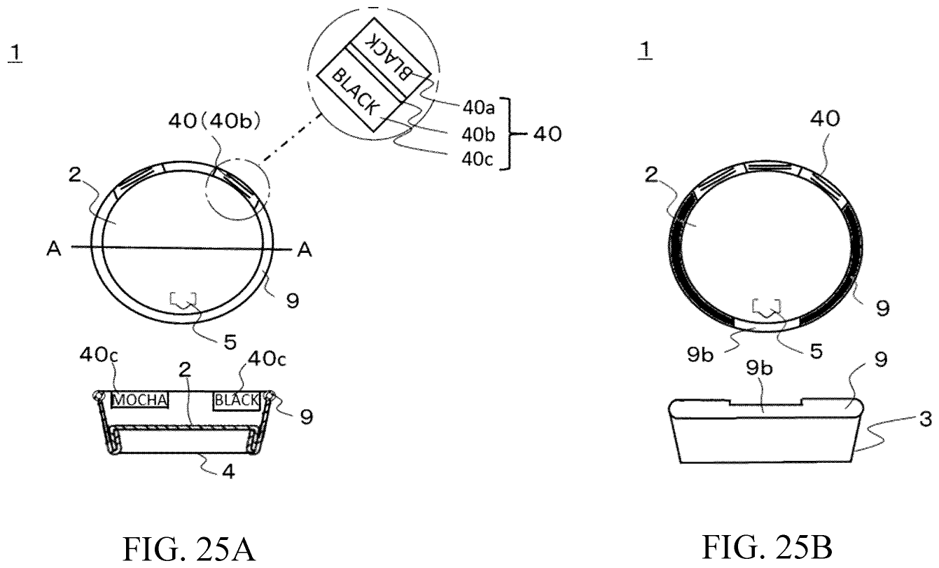

FIG. 25A is a schematic view, a partial enlarged view, and an A-A cross-sectional view illustrating a display portion 40 of the paper lid 1. The partial enlarged view illustrates a state where in order to facilitate understanding, an inside and an outside of a peripheral wall of the paper lid 1 are developed.

Characters, symbols, patterns, or figures are printed on the display portion 40 to identify the content of the container 20. As described above, because the paper lid 1 is made of a paper material, printing can be easily performed. In addition, it is possible to identify whether the content is hot or cold by printing a background color on the display portion 40. For example, a hot beverage may be identified by printing a red color as the background color, and a cold beverage may be identified by printing a light blue color as the background color. In addition, the user can be also reminded of the content by the background color. For example, a black color may be printed as the background color for black coffee, an orange color may be printed for orange juice, and a white color may be printed as the background color for milk. Incidentally, when the background color is a black color, characters, symbols, patterns, or figures may be outlined.

As illustrated in the partial enlarged view, the display portion 40 includes an outside display portion 40a that is printed to correspond to the outside of the peripheral wall of the paper lid 1, a curl display portion 40b that is printed to correspond to the curl portion 9, and an inside display portion 40c that is printed to correspond to the inside of the peripheral wall of the paper lid 1. As shown, the peripheral wall is formed on an outer periphery of the top lid portion 2, and extends to the curl portion 9 to be connected to the curl portion 9.

A plurality of content candidates may be printed as characters on the outside display portion 40a on the outside of the peripheral wall of the paper lid 1 such that mainly a side serving a content can recognize the content. As one example, the content candidates are a mocha coffee and a black coffee in FIG. 25A. Where the number of characters is limited due to the space of the peripheral wall of the paper lid 1, an abbreviation may be printed. For example, where the content is cappuccino, CAPP may be printed.

The curl display portion 40b is displayed in connection with at least one of the outside display portion 40a and the inside display portion 40c. For example, the server serving a content confirms a content of the container 20 among the plurality of content candidates and modifies the curl display portion 40b in connection with the outside display portion 40a indicating the content of the container 20. In this way, other persons (for example, a user or clerks other than himself or herself) can identify the content. Because the curl portion 9 is easily modified by pressing or bending the curl portion 9 with the fingers, even when a writing instrument is not used, the other persons can identify the content.

For this reason, it is preferable that the curl display portion 40b is a linear line or a curved line. For example, the curl display portion 40b is a plurality of curved lines, and the shape of the curved line is deformed due to pressing from above, to become different from the shapes of the curved lines that are not pressed. For this reason, the other persons can identify the content based on a modification of the curl portion 9 or a modification of the print. Where characters are printed on the curl display portion 40b, because the curl portion 9 is deformed into a planar shape when the curl portion 9 is pressed from above, the printed character is seen large and is greatly different in size from the characters that are not pressed. Thereby, it is possible to identify the content. The curl portion 9 is not limited to being deformed by pressing from above, and the curl portion 9 may be bent inward or may be bent outward. In this case, a cut may be provided in the curl portion 9 or the peripheral wall of the paper lid 1.

In addition, a modification such as drilling a hole in the curl portion 9 or the peripheral wall using a hole drilling tool may be performed. In addition, where the content is identified by a modification of the curl portion 9 is determined, the print of the curl display portion 40b may be omitted.

As described above, it is possible to recognize the content by physically modifying the curl portion 9.

The plurality of content candidates may be printed as characters on the inside display portion 40c on the inside of the peripheral wall of the paper lid 1 such that mainly the user can recognize the content. For this reason, it is preferable that the inside display portion 40c is provided together with the curl display portion 40b at a position where the user can see the inside display portion 40c from the drinking spout 5. Specifically, where the drinking spout 5 is on a lower side, it is preferable that the inside display portion 40c be provided at the upper right (first quadrant) or the upper left (second quadrant) of the paper lid 1.

It is preferable that the outside display portion 40a, the curl display portion 40b, and the inside display portion 40c are provided in connection with each other. However, because the server serving the content may be able to recognize the content, the outside display portion 40a may be provided independent of the inside display portion 40c, and can be provided at a random position on the outside of the peripheral wall of the paper lid 1. From the viewpoint of facilitating printing, it is preferable that the printing of the display portion 40 including the curl display portion 40b is performed before the curl portion 9 is formed.

The display portion 40 may be formed as a sticker instead of printing. In addition, the top lid portion 2 may be provided with a mark related to a display of the outside display portion 40a or the inside display portion 40c. In this case, the mark may be drawn on the top lid portion 2 by a writing instrument.

In FIG. 25A, the display portions 40 are provided at two places; however, the display portions 40 may be provided at three or more places. Also in FIG. 25A, a gap is provided between the two display portions 40; however, the length of the gap is a random length, and a plurality of the display portions 40 may be provided without gaps therebetween. FIG. 25B is a view illustrating an example where three display portions 40 are provided without gaps therebetween, which includes a schematic view illustrating the display portions 40 of the paper lid 1 and a front view of the paper lid 1. In FIG. 25B, a step portion 9b is formed in the curl portion 9 to correspond to the drinking spout 5. In addition, the curl portion 9 exclusive of the display portions 40 and the step portion 9b is colored. The coloring of the step portion 9b and the curl portion 9 will be described in a fifth embodiment hereinbelow.

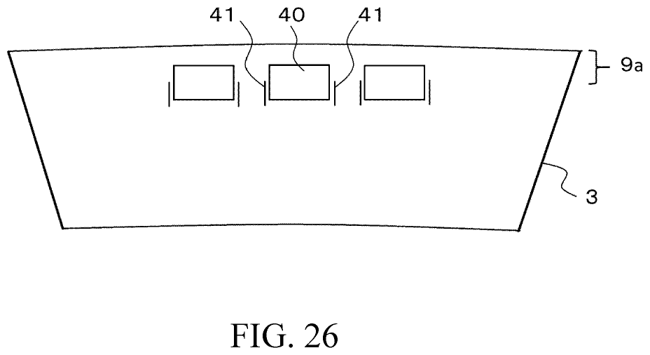

When a part of the curl portion 9 and the peripheral wall of the paper lid 1 are to be modified, as described above, a cut may be provided in the curl portion 9 or the peripheral wall of the paper lid 1. FIG. 26 is a development view of the paper lid 1 excluding the top lid portion 2, and illustrates an example where cut portions 41 are formed on the periphery of the display portion 40. When the cut portions 41 are formed between the plurality of display portions 40 as illustrated in FIG. 25A, two cut portions 41 are required for one display portion 40, and when three display portions 40 are provided, six cut portions 41 are formed. On the other hand, when the three display portions 40 are provided without gaps therebetween as illustrated in FIG. 25B, the cut portions 41 for the display portion 40 at the center can be also used as the cut portions 41 for the display portions 40 on the right and the left. For this reason, when the three display portions 40 are provided, four cut portions 41 are formed.

As illustrated in FIG. 26, the paper lid 1 excluding the top lid portion 2 has a fan shape, and both right and left ends are joined to each other. A curl portion forming region 9a of an upper end portion is curled to form the curl portion 9. Then, the paper lid 1 is obtained by joining the top lid portion 2, which is a separate member, thereto. In addition, joining parts at the both right and left ends become a seam, and the content from the container 20 is prone to leak from the seam. The details of a measure against leakage from the seam will be described later.

Because a tip of the curl portion forming region 9a is rolled inward of the curl portion 9, even when printing of the curl display portion 40b is performed, the curl display portion 40b is not visible. For this reason, printing of the curl display portion 40b may not be performed on the tip of the curl portion forming region 9a. In addition, the curl portion forming region 9a requires rigidity to form a curl, and it is not appropriate to form the cut portions 41 in the curl portion forming region 9a before the curl portion 9 is formed. For this reason, it is preferable that the cut portions 41 are provided away from the curl portion forming region 9a outside both ends of the display portion 40. After the curl portion 9 is formed, cuts may be provided in the curl portion 9 such that a region including the display portions 40 can be bent inward or outward.

From the viewpoint of facilitating production, it is preferable that the cut portions 41 are formed after the display portions 40 are printed; however, the present invention is not limited thereto. Furthermore, the cut portions 41 may be formed after the curl portion 9 is formed. In addition, each of the cut portions 41 may be formed as a half-cut, may be formed discontinuously, or may be provided only on one side of the display portion 40.

When the display portion 40 is bent inward, the print of the outside display portion 40a is visible, and when the display portion 40 is bent outward, the print of the inside display portion 40c is visible. As described above, when a display of the display portion 40 is confirmed by bending the display portion 40, as illustrated in the partial enlarged view of FIG. 25A, the printing of the outside display portion 40a and the inside display portion 40c are not required to be reversed in direction, and the outside display portion 40a and the inside display portion 40c may be printed in the same direction.

Accordingly, the user can see the content of the container 20 by bending the display portion 40 corresponding to the content of the container 20.

It is preferable that a cut portion 41 is formed to not reach the top lid portion 2. This is to prevent the content from the container 20 from leaking from the cut portion 41. In addition, the content may be visible in connection with a display of the display portion 40 by not only bending the cut portion 41 but also modifying the curl portion 9, in which the cut portion 41 is formed, by pressing. In addition, as described above, because the curl portion 9 is modified into a planar shape by pressing from above, the visibility of the characters, the marks, or the figures printed on the curl display portion 40b are improved.

In regard to the size of the drinking spout 5, as one example from the viewpoint of the ease of drinking, a width W1 is from 10 mm to 25 mm, preferably from 15 mm to 22 mm, and a length L1 is from 10 mm to 25 mm, preferably from 14 mm to 21 mm. Where the drinking spout 5 is present at an outer peripheral end (peripheral wall part) of the top lid portion 2, because drinking becomes difficult, a length L2 from the outer peripheral end (peripheral wall part) to the drinking spout 5 may be set to be from 1 mm to 15 mm, preferably from 4 mm to 12 mm. Where the content of the container 20 is a hot beverage and the length L2 is 4 mm or greater, because the temperature of the content decreases while the content travels on the top lid portion 2, it is possible to reduce the risk of a burn when the content is ingested via the outer peripheral end (peripheral wall part). When L2 is shortened to be from 3 mm to 5 mm, it is possible to inhibit the content from spreading out on the top lid portion 2 after the content is ingested from the drinking spout 5.

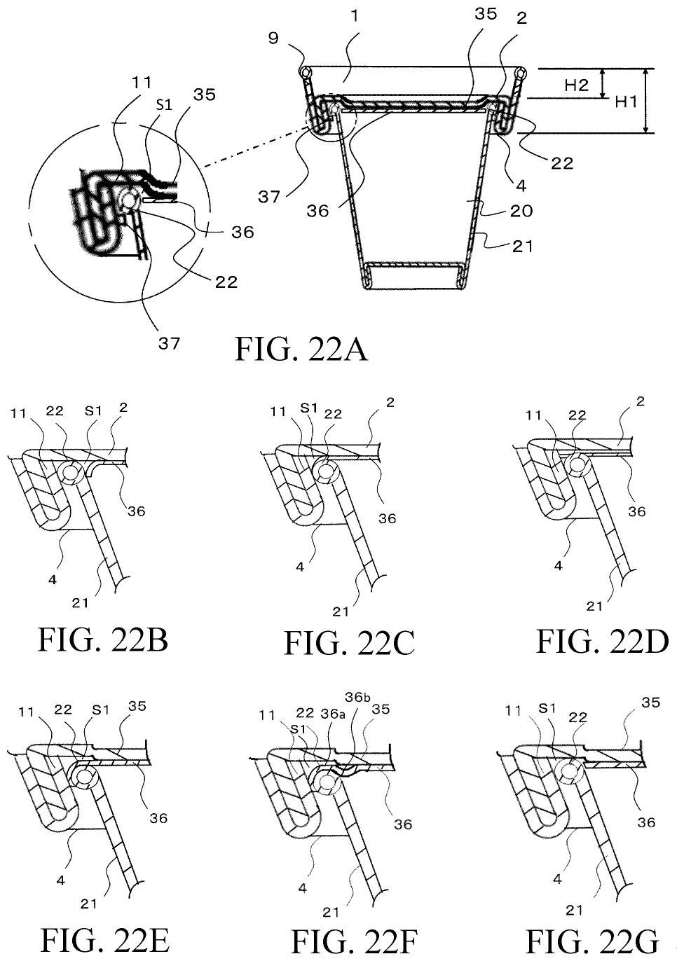

In addition, depending on the setting of a height H2 of the peripheral wall, as will be described later with reference to FIG. 22A, the temperature of the content is capable of decreasing while the content travels over the peripheral wall.

When the ease of drinking and the risk of a burn are taken into consideration, a ratio between the length L1 of the drinking spout 5 and the length L2 of the drinking spout 5 may be from 1.1 to 10, preferably from 1.1 to 5.3. The shape of the drinking spout 5 is not limited to the illustrated shape, and may be any shape. In addition, the drinking spout 5 may be provided with the connected portion 5a or the groove portion 6 illustrated in FIGS. 2A-2D.

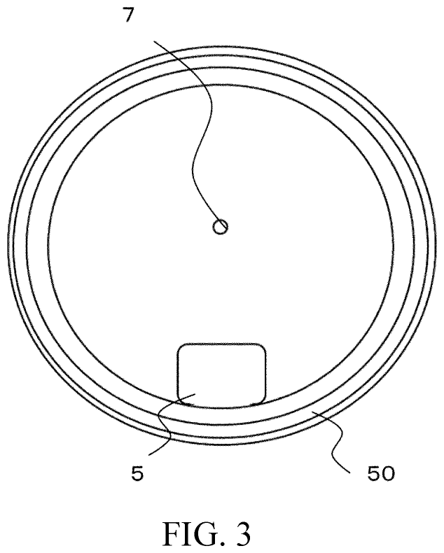

FIG. 3 is a reference view illustrating a plastic lid. The plastic lid in current use is fitted to an outside of the container, and a fitting portion is positioned below the drinking spout 5, so that a lower groove portion 50 is present. When the content is ingested, the content may be spilled from the drinking spout 5 to the lower groove portion 50, so that the usability of the plastic lid is poor. Particularly, an elderly person is prone to spill the content to the lower groove portion 50.

On the other hand, in the present embodiment, the groove portions 6 are present, so that the usability of the paper lid 1 is improved.

Returning to FIGS. 2A-2D, the air hole portion 7 prevents an incident where when the container 20 is covered with the paper lid 1, the paper lid 1 and the container 20 are tightly fitted to each other to cause a liquid leakage. In the present embodiment, the air hole portion 7 is provided to overlap the groove portion 6. Accordingly, the content accumulated in the sunken portion of the top lid portion 2 is also capable of returning into the container 20 from the air hole portion 7. The air hole portion 7 may be provided away from the groove portion 6. The air hole portion 7 is not limited to only preventing a liquid leakage, and serves as a portion through which air in the container escapes when the container is compressed, to have a function of preventing the paper lid 1 fitted to the container from being removed from the container.

One end of the seal portion 8 is a seal portion 8a that closes the drinking spout 5, and the other end 8b thereof has a function to be described later. The seal portion 8 is a releasable seal. The seal portion 8 can be made of a waterproof paper such as a paraffin paper, and a waterproof agent such as a paraffin coat, a silicon, or Teflon (registered trademark) may be applied to the paper.

The other end 8b of the seal portion 8 can be used as a pull-up portion when the seal portion 8 is peeled off. Alternatively, the other end 8b may remain joined to the top lid portion 2 when the seal portion 8a is pulled up to peel off the seal portion 8. As illustrated in FIG. 2B, when an adhesive surface of the seal portion 8a that is to be pulled up is affixed to the tapered portion 21 or the curl portion 22 of the container 20, it is possible to prevent the paper lid 1 from falling off from the container 20 or separating from the container 20 because the paper lid 1 and the container 20 are joined to each other by the seal portion 8. Thereby, it is possible to improve the usability of the paper lid 1.

In addition, a part of an upper side of the curl portion 22 of the container 20 may be collapsed to provide a planar portion, and the planar portion may be joined to a bottom surface of the tapered portion 3 or a bottom surface of the bottom lid portion 4. Ultrasonic sealing, heat sealing, and adhesion can be used as a joining method in this case.

When the other end 8b is pulled up in use, an adhesive agent may not be applied to the other end 8b. On the other hand, when the adhesive surface of the seal portion 8a is affixed to the tapered portion 21 or the curl portion 22 of the container 20, the other end 8b is more firmly bonded thereto than the seal portion 8a. In any case, the adhesive force of the seal portion 8a is different from the adhesive force of the other end 8b.

The container 20 is a paper container including an opening on an upper side thereof, and includes the tapered portion 21, the curl portion 22, and a bottom portion 23. In the present embodiment, because the tapered portion 21 of the container 20 and the tapered portion 3 of the paper lid 1 are tapered reversely to each other, when the paper lid 1 is pushed into the container 20, the sealability between the paper lid 1 and the container 20 is improved. Thereby, even when the container 20 is overturned, it is possible to reduce the risk of spilling the content of the container 20. In addition, various printings can be performed on the paper lid 1. A marker (a line, a mark, or a message) serving as a guide for pushing the paper lid 1 into the container 20 can be printed on the tapered portion 21 (side surface), which will be described later in detail in a third embodiment. When printing is performed on the sunken portion of the top lid portion 2, the user can easily see the printing, and a description of a product or a description of precautions can be given by printing. In addition, the marker (a line, a mark, or a message) serving as a guide for pushing in the paper lid 1 may be provided on a container 20 side, and a precautionary statement to the effect that “please push in the paper lid 1 to the marker on the container 20 side or until the marker is not visible” may be printed on the sunken portion or the tapered portion 3 of the top lid portion 2. Furthermore, a marker or a message of the paper lid 1 and a maker or a message of the container 20 may be aligned with each other to form a new marker or form a new message. The paper lid 1 of the present invention is not limited to being used for a paper container, and can be used as a lid for various containers such as a plastic container and a foamed plastic container.

### Second Embodiment

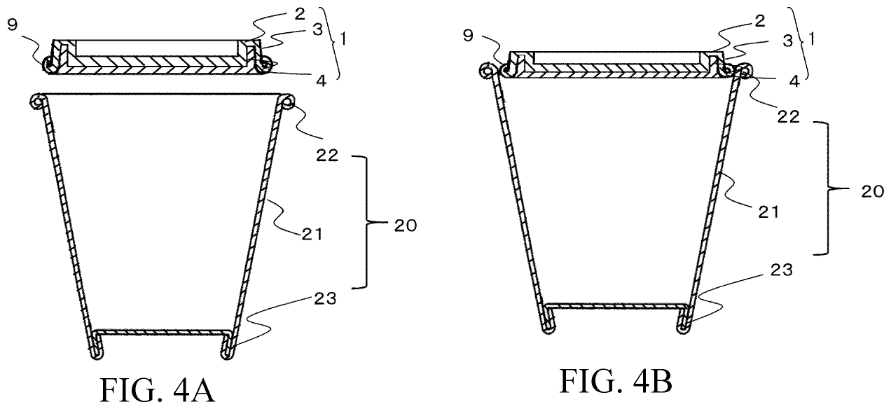

Hereinafter, a second embodiment will be described with reference to FIGS. 4A and 4B. FIGS. 4A and 4B are cross-sectional views of the paper lid 1 and the container 20 of a second embodiment. FIG. 4A is a cross-sectional view illustrating a state where the paper lid 1 is removed from the container 20, and FIG. 4B is a cross-sectional view illustrating a state where the paper lid 1 is fitted to the container 20.

In the present embodiment, the curl portion 9 is provided also in the paper lid 1. The curl portion 9 may be provided integrally with the paper lid 1, or the curl portion 9 as a separate body may be joined to the paper lid 1. A bent portion may be formed in the curl portion 9, and the shape of the bent portion may be any shape.

In the present embodiment, the curl portion 9 and the curl portion 22 differ from each other in size. Where the curl portion 9 is made large, it is possible to improve the sealability between the paper lid 1 and the container 20 when the curl portion 9 and the curl portion 22 are fitted to each other. In this case, even when the container 20 is overturned, it is possible to reduce the risk of spilling the content of the container 20.

A part of a lower end of the curl portion 9 may be collapsed to form one planar portion, a part of an upper end of the curl portion 22 may be collapsed to form one planar portion, and the planar portions may be joined to each other to form a hinge portion. In this case, the size of the curl portion 9 may be smaller than the size of the curl portion 22.

### Third Embodiment

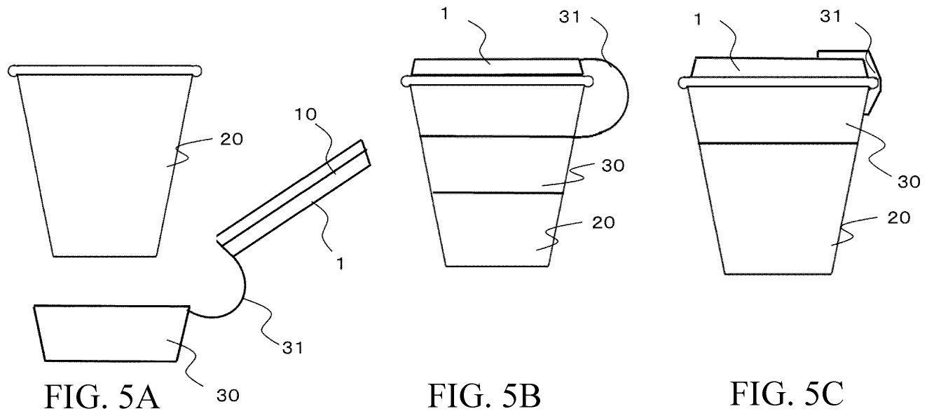

Hereinafter, the third embodiment will be described with reference to FIGS. 5A-5C. FIGS. 5A-5C are schematic views of the paper lid 1 with a holder 30 in the third embodiment. FIG. 5A is a view illustrating a state where the paper lid 1 is not yet mounted on the container 20, and FIGS. 5B and 5C are views illustrating a state where the paper lid 1 is mounted on the container 20.

The holder 30 is made of a paper material, and is a tapered annular member having the same taper as that of the tapered portion 21 of the container 20. A part of the holder 30 which is a tapered annular member may be cut.

In order to prevent the container 20 from being accidentally dropped, unevenness may be provided in a surface of the holder 30 by press working or embossing, or an anti-slipping agent may be applied thereto.

A hinge 31 is a connection member that connects the holder 30 and the paper lid 1. The hinge 31 is made of a paper material, and one end of the hinge 31 is joined to the taper of the holder 30 and the other end thereof is joined to the paper lid 1. In this case, it is desirable that the other end of the hinge 31 is joined to the sunken portion of the top lid portion 2. The hinge 31 may be bent in several stages such that the hinge 31 has a Z-shape and spring properties. The hinge 31 may be made of a yarn or a cloth.

In addition, a mark 10 serving as a marker for pushing the paper lid 1 into the container 20 is printed on a side surface of the paper lid 1.

Various joining methods such as ultrasonic joining, heat sealing, and adhesion can be applied as a method for joining the hinge 31.

The container 20 may have various sizes (an S size, an M size, and an L size), and the diameter of the curl portion 22 or the diameter of the tapered portion 21 differs depending on the size of the container 20. Therefore, in the present embodiment, the size of the paper lid 1 and the size of the holder 30 are set to coincide with each other. For example, where the size of the paper lid 1 is an L size, the holder 30 also has an L size.

Accordingly, a position where the holder 30 is locked to the container 20 is fixed. Thus, the user does not feel discomfort.

FIG. 5B illustrates an example where the holder 30 is positioned in a central portion of the container 20 in the height direction. In addition, the example illustrates a state where the hinge 31 excluding both end portions is not joined to the paper lid 1 and the container 20.

FIG. 5C is an example where the holder 30 is positioned in an upper portion of the container 20 in the height direction. The example illustrates a state where the hinge 31 is attached in contact with the paper lid 1 and the holder 30. In this case, where the hinge 31 is in contact with the side surface of the top lid portion 2 and the sunken portion, the top lid portion 2 can be pressed against the container 20 by the hinge 31. Therefore, it is possible to prevent the paper lid 1 from falling off from the container 20 or separating from the container 20. Thereby, it is possible to improve the usability of the paper lid 1. Also in this case it is desirable that the paper lid 1 and the container 20 are joined to each other by the seal portion 8.

Also in FIG. 5B, the hinge 31 may be in contact with the paper lid 1 and the container 20.

In the present embodiment, the tapered portion 3 of the paper lid 1 may be the same taper (forward taper) as the tapered portion 21 of the container 20.

### Fourth Embodiment

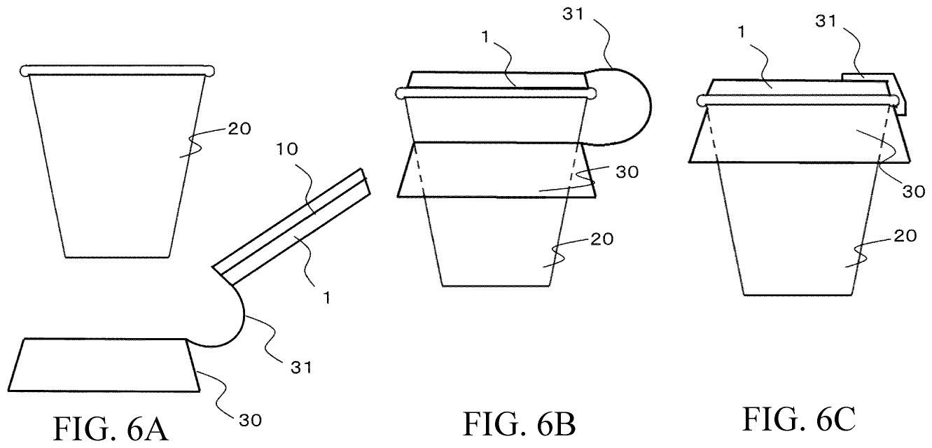

Hereinafter, a fourth embodiment will be described with reference to FIGS. 6A-6C. FIGS. 6A-6C are schematic views of the paper lid 1 with the holder 30 in the fourth embodiment. FIG. 6A is a view illustrating a state where the paper lid 1 is not yet mounted on the container 20, and FIGS. 6B and 6C are views illustrating a state where the paper lid 1 is mounted on the container 20.

In the present embodiment, the holder 30 is a tapered annular member having a taper reverse to that of the tapered portion 21 of the container 20. A part of the holder 30 that is a tapered annular member may be cut.

In the present embodiment, the tapered portion 3 of the paper lid 1 may be the same taper (forward taper) as the tapered portion 21 of the container 20.

In the third embodiment and the fourth embodiment, because the paper lid 1 and the holder are integrated via the hinge 31, even when the content of the container 20 is hot, the container 20 does not become too hot to be held, and the content of the container 20 does not even cool down.

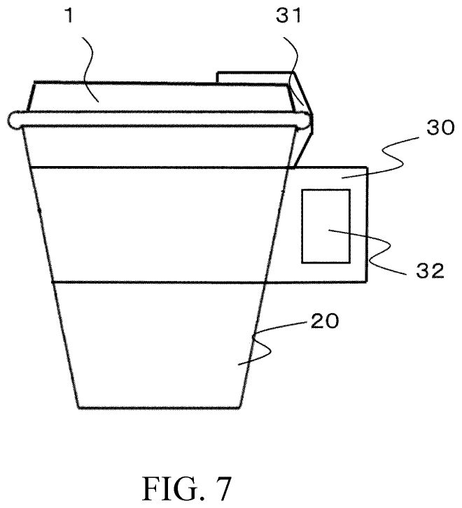

FIG. 7 is a modification example of the paper lid 1 with the holder 30 of the third embodiment and the fourth embodiment, and illustrates an example where the paper lid 1 is provided with a handgrip and a holder. As illustrated in FIG. 7, the holder 30 is extended in a horizontal direction, and a handgrip is provided by providing an opening portion 32 in an extended part. As described above, because the lid, the holder, and the handgrip are integrally formed, the container 20 can be easily carried.

Because the paper lids 1 of the first embodiment and the second embodiment can be stored or transported in a stacking manner, it is possible to reduce logistics costs.

Because the paper lids 1 with the holders 30 of the third embodiment and the fourth embodiment can be stored or transported in a stacking manner, it is possible to reduce logistics costs.

In addition, in the lid illustrated in the reference view of FIG. 3, when the lid is removed from the container and a drinking spout 5 side is placed on a table, the drinking spout 5 comes into contact with the table, which is not hygienic. Further, when the lid is placed on the table with the drinking spout 5 side down, because the content of the container is on a bottom side of the lid, the content adheres to the table, which needs to be cleaned.

In contrast, in the paper lid 1 with the holder 30 of the third embodiment and the fourth embodiment, when the paper lid 1 is removed, the paper lid 1 is held by the holder 30. Therefore, the drinking spout 5 does not come into contact with a table, and the content which adheres to the bottom lid portion 4 due to the tapered portion 3 does not fall onto the table. Thereby, it is possible to improve the usability of the paper lid 1.

### Fifth Embodiment

In the examples described in the foregoing embodiments, the tapered portion 3 is fitted to an inside of the container 20, so that the paper lid 1 is fitted to the inside of the container 20. An example where the paper lid 1 is fitted to the outside of the container 20 will be described below.

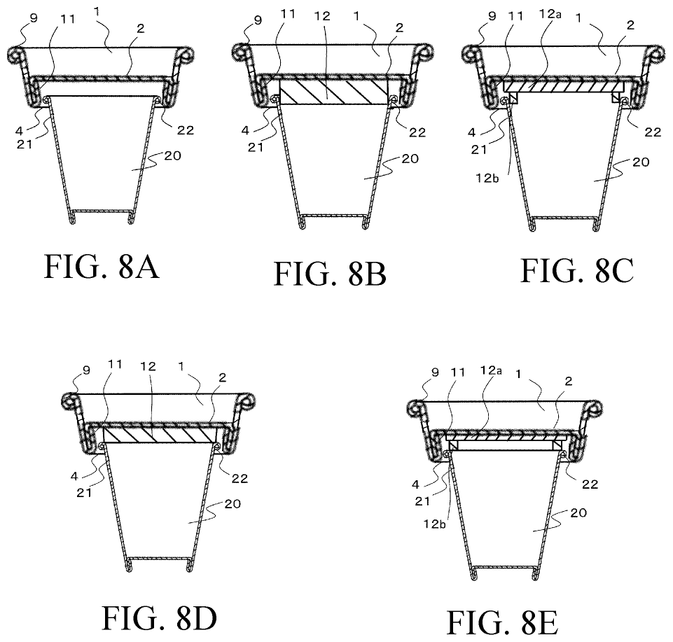

FIGS. 8A-8E are schematic views of the paper lid 1 of the fifth embodiment. Five examples of the paper lid 1 are disclosed in FIG. 8A to FIG. 8E, which are hereinafter sequentially described. To simplify the drawings, the drinking spout 5 and the like are not illustrated. The size of the paper lid 1 is illustrated in an exaggerated manner, and the dimensions of the paper lid 1 are not limited to the illustrated dimensions.

In the paper lid 1 of FIG. 8A, a second tapered portion 11 is provided that is fitted to an outside of the curl portion 22. Because the paper lid 1 is fitted to the outside of the container 20, the dimension of the paper lid 1 is larger compared to when the paper lid 1 is fitted to the outside of the container 20. As illustrated in FIG. 8A, where the second tapered portion 11 is fitted to the curl portion 22, it is possible to reduce the prime cost of the paper lid 1. The paper lid 1 described above is suitable as a lid for the container 20 for a cold beverage.

The paper lid 1 of FIG. 8B is provided with an engaging portion 12 that is capable of engaging with an inside of the curl portion 22, in addition to the second tapered portion 11. The engaging portion 12 is made of a paper material. The shape of the engaging portion 12 may be any shape such as a circular shape, an oval shape, or a rectangular shape, and is a circular shape in the present embodiment. In the present embodiment, the engaging portion 12 is formed separately from the paper lid 1, and is joined to the paper lid 1 using various joining methods such as adhesion or ultrasonic joining. When joining parts of the paper lid 1 and the engaging portion 12 are coated with films, the paper lid 1 and the engaging portion 12 can be joined to each other by heat sealing.

Because the curl portion 22 is positioned between the second tapered portion 11 and the engaging portion 12, it is possible to reduce the risk that the paper lid 1 is removed from the container 20. For this reason, the engaging portion 12 may not be always in contact with the curl portion 22. For example, when the paper lid 1 is fitted to the container 20 and the second tapered portion 11 is fitted to the curl portion 22, there may be a clearance of approximately 0.1 mm to 1.5 mm between the engaging portion 12 and the curl portion 22. The engaging portion 12 may be shaped to engage with the entire periphery of the curl portion 22, or may be shaped to engage with the curl portion 22 at several places.

In the paper lid 1 of FIG. 8C, the engaging portion 12 includes a base portion 12a and an engaging part 12b. The base portion 12a and the engaging part 12b may be integrally formed, or after the base portion 12a and the engaging part 12b are separately formed, the base portion 12a and the engaging part 12b may be joined to each other. As illustrated in FIG. 8C, the engaging part 12b may be capable of engaging with the curl portion 22 at two places, or alternatively, the engaging part 12b may be shaped to engage with the entire periphery of the curl portion 22.

As described above, because the engaging portion 12 includes the base portion 12a and the engaging part 12b, it is possible to reduce the amount of paper material used for the engaging portion 12.

In FIGS. 8A to 8C, the second tapered portion 11 is illustrated as being tapered forward. However, the second tapered portion 11 may be a reverse taper, and may not be tapered but have a linear shape. Where the paper lid 1 is fitted to the outside of the container 20, the tapered portion 3 may have a linear shape.

In addition, when the curl portion 9 is collapsed in the height direction (in the Z direction), the height of the curl portion 9 is increased, and the distance from the drinking spout 5 formed in the sunken portion is increased. Thereby, it is possible to realize the paper lid 1 that allows easier drinking. It is preferable that the curl portion 9 is from approximately 0.5 mm to 1 mm in a width direction. When the curl portion 9 is collapsed by press working, it is possible to improve the press workability of the curl portion 9 by heating a part (for example, a lower die holding the paper lid 1) of a press machine to 50° C. to 90° C. In addition, when the curl portion 9 is collapsed, because the exterior of the paper lid 1 can be reduced, it is possible to increase the number of the paper lids 1 to be transported, reducing the transportation cost per unit of the paper lids 1.

In FIG. 8B, the engaging portion 12 and the curl portion 22 engage with each other from the inside of the curl portion 22. However, as illustrated in FIG. 8D, the engaging portion 12 and the curl portion 22 may engage with each other from above the curl portion 22. In this latter case, it is desirable that the engaging portion 12 and the curl portion 22 engage with each other inside a center of a curl of the curl portion 22.

Similarly, in FIG. 8C, the engaging part 12b and the curl portion 22 engage with each other from the inside of the curl portion 22. However, as illustrated in FIG. 8E, the engaging part 12b and the curl portion 22 may engage with each other from above the curl portion 22. In this latter case, it is desirable that the engaging portion 12 and the curl portion 22 engage with each other inside a center of a curl of the curl portion 22.

As illustrated in FIGS. 8A-8E, when the curl portion 9 is formed on an upper side of the paper lid 1 and the second tapered portion 11 and the tapered portion 21 are tapered forward, it is preferable that the dimension of the inner diameter of a tip (bottom lid portion 4 side) of the second tapered portion 11 is the same as or is slightly smaller than that of the outer diameter of the curl portion 22. Accordingly, when the paper lid is fitted to the container 20, the curl portion 22 is collapsed (modified), so that the paper lid 1 and the container 20 are fitted to each other. Thereby, it is possible to improve the sealability between the paper lid 1 and the container 20.

Even when the second tapered portion 11 and the tapered portion 21 are tapered forward, the taper angle of the second tapered portion 11 may be set to be from 3 to 5 degrees and the taper angle of the tapered portion 21 may be set to be from 6 to 7 degrees such that the taper angles are different from each other.

At least a part (part that engages with the curl portion 22) of an inner peripheral surface of the second tapered portion 11 may not be provided with a coating layer. Accordingly, the paper material of the inner peripheral surface of the second tapered portion 11 engages with the curl portion 22 provided with the coating layer. Thus, due to the friction of the paper material, the second tapered portion 11 and the curl portion 22 become less slippery, making it possible to improve the sealability between the paper lid 1 and the container 20. In addition, because the content of the container 20 penetrates through the paper material of the inner peripheral surface of the second tapered portion 11 to cause the second tapered portion 11 to swell, it is possible to improve the sealability between the paper lid 1 and the container 20.

In the reference example illustrated in FIG. 3, because a fitting portion that is fitted to the container 20 is present at the same position as the lower groove portion 50 or below the lower groove portion 50, when the plastic lid is removed from the vicinity of the fitting portion, there is a risk that the content reaches the hand of the user to cause a burn.

In contrast, in the present embodiment, as described above, because the curl portion 9 is present above a position where the paper lid 1 and the container 20 are fitted to each other, the curl portion 9 or a peripheral wall on the periphery of the curl portion 9 can be held by the hand and then the paper lid 1 can be simply removed from the container 20. Thereby, there is no risk that the content reaches the hand of the user.

In addition, in the reference example illustrated in FIG. 3, because the plastic lid is removed from below the drinking spout 5, there is a risk that the content splashes out from the drinking spout 5 to reach the hand of the user.

In contrast, in the present embodiment, because the curl portion 9 or the peripheral wall on the periphery of the curl portion 9 that is present above the drinking spout 5 and is formed on the upper side of the paper lid 1 is held by the hand and then the paper lid 1 is removed, there is no risk that the content splashes out from the drinking spout 5 to reach the hand of the user. Where the curl portion 9 or the peripheral wall on the periphery of the curl portion 9 is held by the hand and then the paper lid 1 is mounted or removed, from the viewpoint of hygiene, it is desirable that the curl portion 9 in the vicinity of the drinking spout 5 is not touched by a hand. Therefore, as illustrated in FIG. 25B, when the curl portion 9 exclusive of the display portions 40 and the step portion 9b is colored, it is possible to call the attention of the user. In addition to that, for example, a precautionary statement to the effect that a colored part of the top lid portion 2 is held and then the paper lid is mounted or removed is desirably printed.

Instead of coloring the top lid portion 2 or in conjunction with coloring the top lid portion 2, the step portion 9b is provided. Thereby, it is possible to inhibit the user from touching the curl portion 9 in the vicinity of the drinking spout 5 by their hand.

Incidentally, when the paper lid 1 is a type where the paper lid 1 is removed and then the content of the container 20 is drunk, the drinking spout 5 can be omitted.

As illustrated in FIGS. 8A-8E, when the curl portion 9 is formed on the upper side of the paper lid 1, the user puts their mouth on the curl portion 9 to drink the content from the drinking spout 5 formed in the top lid portion 2. This provides the same mouth feel as when the user puts their mouth on the curl portion 22 to drink the content from the container 20 made of a paper. For this reason, the user does not feel discomfort that the user feels when drinking the content from the drinking spout of a plastic lid. In addition, because the tapered portion 3 and the tapered portion 21 are tapered forward, the user can put their mouth on the curl portion 9 to drink the content from the drinking spout 5 at the same angle as when the user drinks the content from the container 20 made of a paper. Accordingly, the user can drink the content from the paper lid 1 with the same mouth feel as when the user drinks the content from the container 20 made of paper.

### Sixth Embodiment

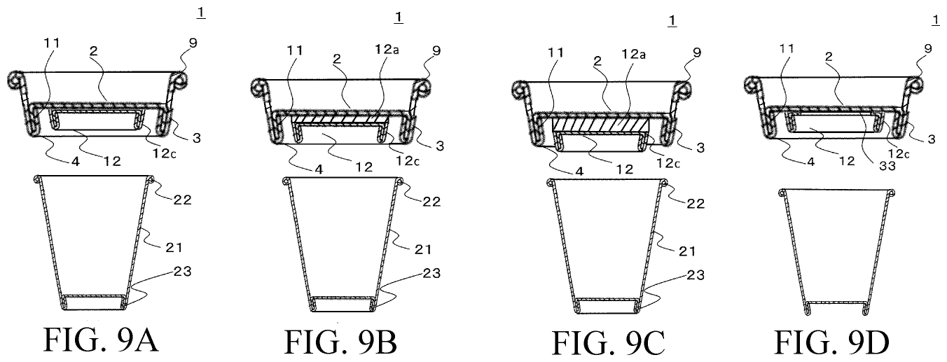

FIGS. 9A-9D are schematic views of the paper lid 1 of a sixth embodiment, and illustrates, similarly to the fifth embodiment, an example where the paper lid 1 is fitted to the outside of the container 20. Four examples of the paper lid 1 are disclosed in FIGS. 9A-9D, which are hereinafter sequentially described. To simplify the drawings, the drinking spout 5 and the like are not illustrated.

In the present embodiment, the engaging portion 12 is tapered, so that a tapered portion 12c is formed. The tapered portion 12c is the same taper (forward taper) as the second tapered portion 11. However, the tapered portion 12c may be a reverse taper having a different taper direction or may have a different taper angle.

In the paper lid 1 of FIG. 9A, the tip of the second tapered portion 11 protrudes further toward the container 20 than a tip of the tapered portion 12c such that the second tapered portion 11 starts engaging with the curl portion 22 and then the tapered portion 12c engages with the curl portion 22. In other words, the engaging portion 12 is positioned in a space that is formed inside the second tapered portion 11. For this reason, when the second tapered portion 11 engages with the curl portion 22, the curl portion 22 and an upper portion of the tapered portion 21 receive an inward force. When the tapered portion 12c engages with the curl portion 22 in this state, the curl portion 22 and the upper portion of the tapered portion 21 receive an outward force. Thereby, the paper lid 1 can be firmly fitted to the container 20. As described above, when the taper length of the tapered portion 12c is set to be shorter than the taper length of the second tapered portion 11, the paper lid 1 can be easily removed from the container 20. Also, because the taper length of the tapered portion 12c is set to be larger than the diameter of the curl portion 22, the paper lid 1 can be reliably fitted to the container 20; and thereby, even when the temperature of the content of the container 20 is high, it is possible to reduce an accident caused by a burn.

Incidentally, a curl portion may be formed in an upper surface of the engaging portion 12, and the engaging portion 12 and the bottom lid portion 4 may be joined to each other by the curl portion.

In the paper lid 1 of FIG. 9B, the tip of the second tapered portion 11 and the tip of the tapered portion 12c are to be aligned with each other such that the second tapered portion 11 and the tapered portion 12c engage with the curl portion 22 almost at the same time. In the present embodiment, the tip of the second tapered portion 11 and the tip of the tapered portion 12c are aligned with each other by the base portion 12a; however, the size of at least one of the second tapered portion 11 and the tapered portion 12c may be adjusted such that the tip of the second tapered portion 11 and the tip of the tapered portion 12c are aligned each other. As described above, because the tip of the second tapered portion 11 and the tip of the tapered portion 12c are aligned with each other, the paper lid 1 can be fitted to the container 20 in a well-balanced manner.

In the paper lid 1 of FIG. 9C, the tip of the tapered portion 12c protrudes further toward the container 20 than the tip of the second tapered portion 11 such that the tapered portion 12c starts engaging with the curl portion 22 and then the second tapered portion 11 engages with the curl portion 22. In the present embodiment, the tip of the tapered portion 12c is caused to protrude further toward the container 20 than the tip of the second tapered portion 11 by the base portion 12a. However, the size of at least one of the second tapered portion 11 and the tapered portion 12c may be adjusted such that the tip of the tapered portion 12c protrudes toward the container 20 than the tip of the second tapered portion 11. As described above, because the tip of the tapered portion 12c protrudes further toward the container 20 than the tip of the second tapered portion 11, the second tapered portion 11 can be guided to fit to the curl portion 22 by the engagement between the tapered portion 12c and the curl portion 22. Accordingly, the paper lid 1 can be easily fitted to the container 20.

FIG. 9D is an example where an opening portion 33 is provided in the upper surface of the engaging portion 12. Due to the opening portion 33, the top lid portion 2 and the engaging portion 12 are joined to each other only via an outer periphery of the engaging portion 12. Thereby, the weight of the engaging portion 12 can be reduced. In addition, an opening portion may be formed in the top lid portion 2 to reduce the weight of the top lid portion 2.

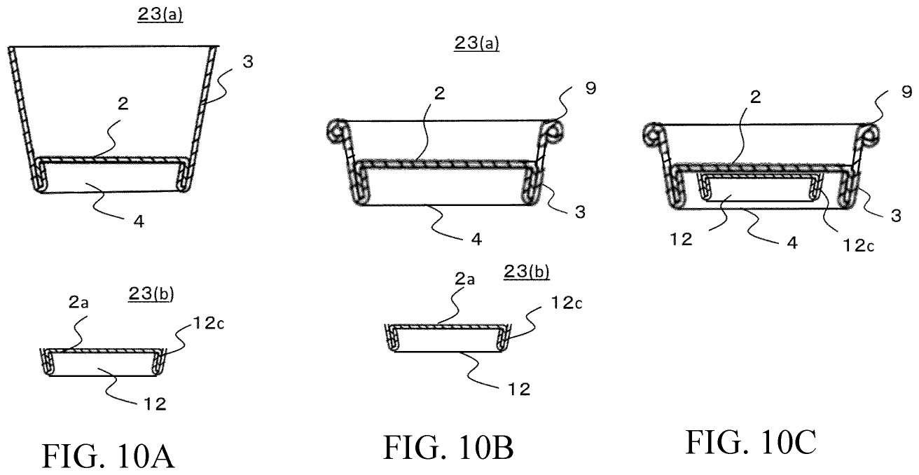

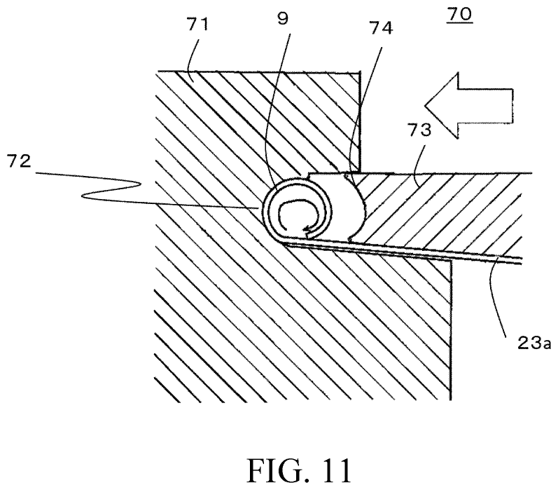

FIGS. 10A-10C and 11 are views illustrating a method for producing the paper lid 1 of the sixth embodiment. Hereinafter, the method for producing the paper lid 1 in the sixth embodiment will be described with reference to these figures. The paper lid 1 of the sixth embodiment is the paper lid 1 that is produced using the bottom portion 23 of the container 20 having a different size. However, the present invention is not limited thereto, and the paper lid 1 can be produced of a paper material by press working or papermaking. In this case, it is possible to improve the press workability of the paper lid 1 by heating at least a part (for example, the lower die holding the paper lid 1) of the press machine to 50° C. to 90° C. The paper lid 1 illustrated in FIG. 9A will be described as an example.

FIG. 10A illustrates two bottom portions 23a and 23b of the container 20, of which the sizes are different from each other. The bottom portion 23a is formed according to the size of the outside (outer diameter) of the curl portion 22. The bottom portion 23b is formed according to the size of the inside (inner diameter) of the curl portion 22. As is apparent from FIG. 10A, a part of the bottom portion 23a (the top lid portion 2 and the bottom lid portion 4) has a similar shape as that of the bottom portion 23b. For this reason, where the tapered portion 3 serves as a first engaging portion, the tapered portion 12c serves as a second tapered portion, and the paper lid 1 is fitted to the container. Even in a case where the container 20 is overturned, it is possible to reduce the risk of spilling the content of the container 20. In addition, the basis weights of the bottom portion 23a and the bottom portion 23b may be the same; however, because the bottom portion 23a requires strength due to being fitted to the outside of the container 20, it is desirable that the basis weight of the bottom portion 23a is larger than the basis weight of the bottom portion 23b. As one example, the basis weight of the bottom portion 23a is from 200 g/m² to 360 g/m², and the basis weight of the bottom portion 23b is from 150 g/m² to 199 g/m². In this case, where the basis weight of the second tapered portion 11 is 200 g/m² to 360 g/m², and the basis weight of the tapered portion 12c is 150 g/m² to 199 g/m², the paper lid 1 is easily removed because the resistance (rigidity) of the tapered portion 12c is reduced.

The bottom portion 23a and the bottom portion 23b may be made of the same paper material, or may be made of different paper materials.

In FIG. 10B, the curl portion 9 is formed on an upper side of the bottom portion 23a. FIG. 11 is a partial enlarged view of a curl molding die 70. The curl molding die 70 includes an upper die 71, an upper die groove portion 72, a lower die 73, and a lower die groove portion 74. The upper die 71 includes a tip portion into which the upper side of the bottom portion 23a is capable of entering. In addition, the upper die 71 includes the upper die groove portion 72 having a curved surface shape. The lower die 73 includes a holding portion that holds the bottom portion 23a, and the lower die groove portion 74 that is opposite to the upper die groove portion 72.

When the lower die 73 holding the bottom portion 23a moves toward the upper die 71, a tip of the bottom portion 23a comes into contact with the upper die groove portion 72, slides on a surface of the upper die groove portion 72 along the curved surface of the upper die groove portion 72, stretches out to be opened outward, is gradually curled, and then comes into contact with the lower die groove portion 74. Accordingly, the upper side of the bottom portion 23a is curled.

FIG. 10C illustrates a mode where a top lid portion 2a of the bottom portion 23b is joined to a lower side of the top lid portion 2 of the bottom portion 23a. Various joining methods such as adhesion and ultrasonic joining can be applied as a method for joining the top lid portion 2 and the top lid portion 2a. For example, where joining parts of the top lid portion 2 and the top lid portion 2a are coated with films, because the sunken portion of the top lid portion 2 and a sunken portion of the top lid portion 2a are formed as flat surfaces, the top lid portion 2 and the top lid portion 2a can be joined to each other by heat sealing. It is desirable that the top lid portion 2 and the top lid portion 2a are joined to each other in a state where the centers of the top lid portion 2 and the top lid portion 2a are aligned with each other; however, the present invention is not limited thereto. For example, the centers of the top lid portion 2 and the top lid portion 2a may be eccentric from each other such that the second tapered portion 11 and the tapered portion 12c are tightly fitted to the curl portion 22 in the drinking spout 5 and in the vicinity of the drinking spout 5.

It is possible to produce the paper lid 1 by joining the top lid portion 2 and the top lid portion 2a and then processing the drinking spout 5 or the air hole portion 7.

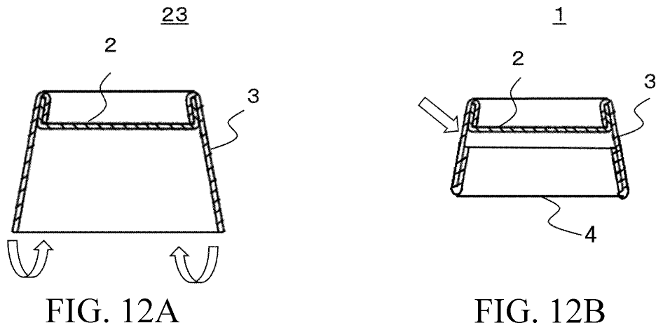

FIGS. 12A and 12B are views illustrating another method for producing the paper lid 1. In the present embodiment, the paper lid 1 is produced using the bottom portion 23 of the container 20. However, the present invention is not limited thereto, and the paper lid 1 can be produced of a paper material by press working.

In FIG. 12A, the bottom portion 23 of the container 20 is cut to a predetermined size, and a lower end portion is bent inward as indicated by the arrows.

FIG. 12B is a view after the lower end portion is bent inward. Because the lower end portion is bent inward, a part where the paper material is double layered and a single-layer part (part indicated by an arrow) are present. When the paper lid 1 is fitted to the container 20, the curl portion 22 of the container 20 is caught and held by the single-layer part. Furthermore, because the tapered portion 3 of the paper lid 1 is fitted to the tapered portion 21 of the container 20, the paper lid 1 can be firmly fitted to the container 20.

In the present embodiment, the tapered portion 3 of the paper lid 1 and the tapered portion 21 of the container 20 are tapered reversely to each other. However, the tapered portion 3 of the paper lid 1 and the tapered portion 21 of the container 20 may be tapered forward, or the tapered portion 3 may have a linear shape. Where the lower end portion is bent inward and a protruding portion is provided in an inner surface of the lower end portion or the inner surface is made wavy, the paper lid 1 can be more firmly fitted to the container 20.

The technique where the curl portions are fitted to each other as illustrated in FIGS. 4A and 4B, and the technique where the curl portion and the tapered portion are fitted to each other as illustrated in FIGS. 9A-9D and 10A-10C are disclosed in Japan Patent Application No. 2018-138005, filed on Jul. 23, 2018 based on U.S. Provisional Application No. 62/696,895, filed on Jul. 12, 2018 by Applicant of the instant application, the content of which is incorporated herein, and the description thereof is as follows. Only reference signs of parts having duplicative reference signs to the description herein are changed.

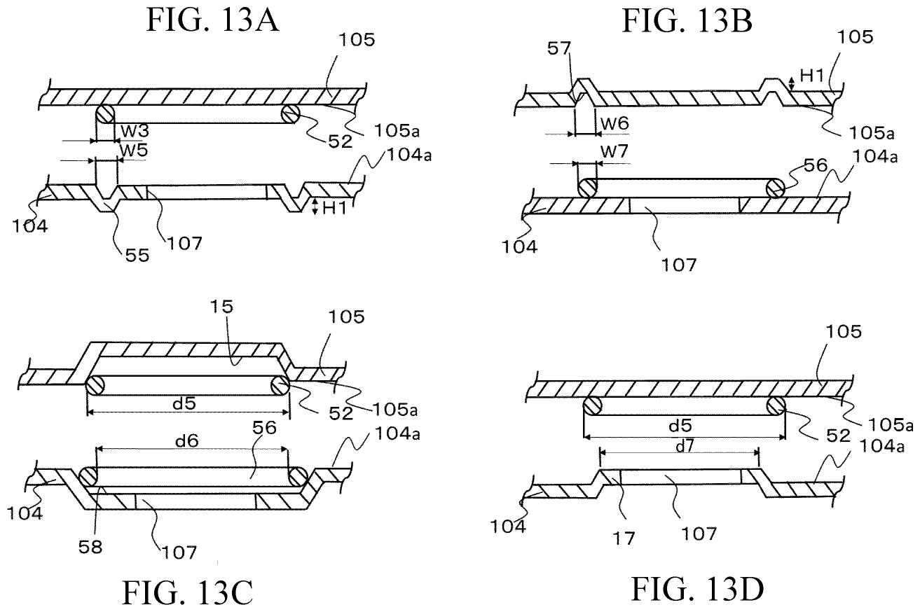

FIGS. 13A-13D (FIG. 38 in Japan Patent Application No. 2018-138005) are views illustrating other examples of a fitting member using a curl member 52 (56). FIG. 13A is a view illustrating an example where an attaching portion 104 is provided with a recessed groove portion 55 having a tapered annular shape. The taper of the recessed groove portion 55 having a tapered annular shape is narrowed from an upper surface toward a lower surface of the attaching portion 104. For this reason, a fitting width W5 of the upper surface of the attaching portion 104 is larger (wider) than a fitting width W3 of the curl member 52.

FIG. 13B is a view illustrating an example where the attaching portion 104 is provided with a curl member 56 and a lid portion 105 is provided with a recessed groove portion 57 having a tapered annular shape. The configuration of the curl member 56 is the same as that of the curl member 52. A width W6 on an opposite surface side of the recessed groove portion 57 having a tapered annular shape, which is opposite to the attaching portion 104, is larger (wider) than a fitting width W7 of the curl member 56.

FIG. 13C illustrates an example where the lid portion 105 is provided with a recessed portion 15 of which the peripheral edge is formed into a tapered annular shape, and the curl member 52 is joined to the recessed portion 15 having a tapered annular shape. Because the curl member 52 is joined along a taper surface of the recessed portion 15, the positioning of the curl member 52 can be facilitated. In addition, a part of the curl member 52 protrudes from the recessed portion 15 toward the attaching portion 104.

FIG. 13C also illustrates an example where the attaching portion 104 is provided with a recessed portion 58 of which the peripheral edge is formed into a tapered shape, and the curl member 56 is joined to the recessed portion 58 such that the curl member 56 is accommodated in the recessed portion 58. Because the curl member 56 is joined along a taper surface of the recessed portion 58, the positioning of the curl member 56 can be facilitated.

A major diameter d5 of the curl member 52 is larger than an inner diameter d6 of the curl member 56. When the lid portion 105 is opened, at least one of the curl member 52 and the curl member 56 is elastically deformed, so that the curl member 52 is fitted internally to the curl member 56.

In FIG. 13D, the attaching portion 104 is provided with a protruding portion 17 of which the periphery has a tapered shape. The major diameter d5 of the curl member 52 is larger than an outer diameter d7 of the protruding portion 17. When the lid portion 105 is opened, the curl member 52 is elastically deformed, so that the curl member 52 is fitted externally to the protruding portion 17.

In FIGS. 13A-13D, the shapes and the sizes of the curl members 52 and 56, the recessed groove portions 55 and 57, and the recessed portion 58 are preferably set such that an upper surface 104a of the attaching portion 104 and an upper surface 105a of the lid portion 105 come into contact with each other when the lid is open. In addition, a foamable ink or a foamable hotmelt containing a foaming agent may be applied to or foamed in at least a part of the curl members 52 and 56, the recessed groove portions 55 and 57, and the recessed portions 15 and 58. The recessed groove portions 55 and 57, the recessed portions 15 and 58, and the protruding portion 17 can be formed by press working.

As is apparent from the above description, the technique where the curl portions are fitted to each other or the technique where the curl portion and the tapered portion are fitted to each other is disclosed in Japan Patent Application No. 2018-138005.

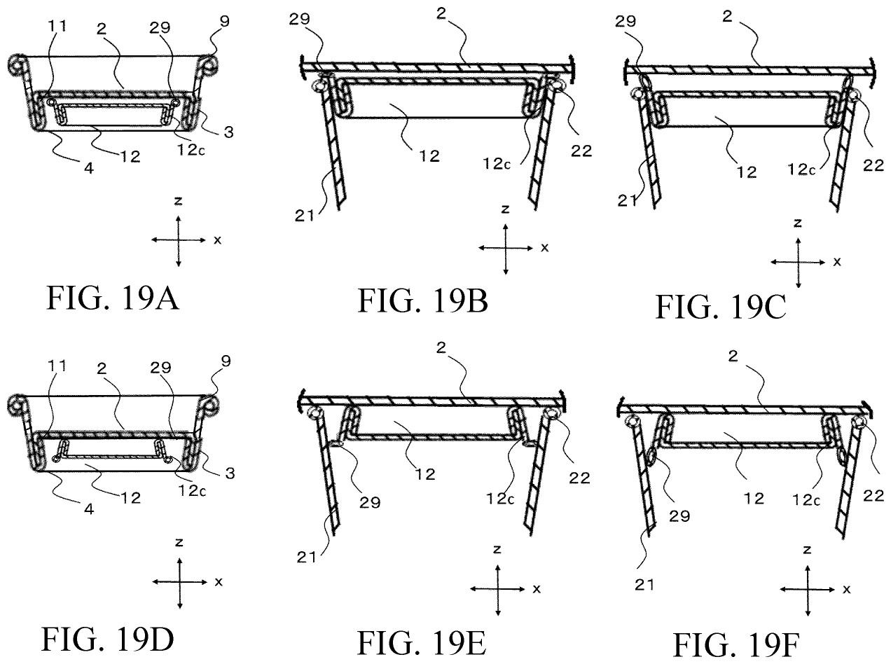

Other forms of fitting can be also applied to the paper lid 1 of the sixth embodiment described above. FIGS. 19A-19F show a modification example of the paper lid of the sixth embodiment, and six examples are disclosed and sequentially described. Here, FIGS. 19A-19C illustrate examples where the tapered portion 12c of the engaging portion 12 and the tapered portion 21 of the container 20 are tapered forward, and FIGS. 19D-19F illustrate examples where the tapered portion 12c of the engaging portion 12 and the tapered portion 21 of the container 20 are tapered reversely to each other. To simplify the drawings, the drinking spout 5 and the like are not illustrated.

In FIG. 19A, a curl portion 29 is formed in the upper surface of the engaging portion 12, and the engaging portion 12 and the top lid portion 2 are joined to each other by the curl portion 29. Because the curl portion 29 and the curl portion 22 of the container 20 are fitted to or engage with each other, the second tapered portion 11 and the curl portion 22 are fitted to or engaged with each other, and the tapered portion 12c of the engaging portion 12 and an inner surface of the tapered portion 21 of the container 20 are fitted to each other. Even when the container 20 is overturned or is severely inclined, it is possible to improve the sealability between the paper lid 1 and the container 20 because the fitting or the engagement at the foregoing three places and both are used. Thereby, it is possible to reduce the risk of spilling the content of the container 20.

FIG. 19B illustrates an example where the curl portion 29 is collapsed along a Z-axis to be extended in an X-axis direction of the same drawing. As described above, because it is possible to increase a joining area between the curl portion 29 and the top lid portion 2 by flattening and lengthening the curl portion 29 horizontally, the engaging portion 12 can be reliably joined to the top lid portion 2. Further, because a contact area between the curl portion 29 and the curl portion 22 can be increased, it is possible to reduce the risk of spilling the content of the container 20. The curl portion 29 can be collapsed along the Z-axis to be extended in the X-axis direction by press working.

FIG. 19C illustrates an example where the curl portion 29 is collapsed along an X-axis to be extended in a Z-axis direction of the same drawing. As described above, because the curl portion 29 is lengthened vertically, a space is formed between a lower surface of the top lid portion 2 and an upper surface of the bottom lid portion 4 and the space serves as a heat insulating portion. Thereby, it is possible to improve the heat retention of the content in the container 20. Further, because a contact area between the curl portion 29 and the curl portion 22 can be increased, it is possible to reduce the risk of spilling the content of the container 20. The curl portion 29 can be collapsed along the Z-axis to be extended in the X-axis direction by press working. The curl portion 29 serves as a packing, and accordingly, it is possible to reduce the risk of spilling the content of the container 20.

FIG. 19D illustrates an example where the engaging portion 12 illustrated in FIG. 19A is joined to the top lid portion 2 in a state where the engaging portion 12 is turned upside down. Accordingly, the tapered portion 12c of the engaging portion 12 and the tapered portion 21 of the container 20 are tapered reversely to each other.

Where the tapered portion 12c and the tapered portion 21 are tapered reversely to each other, because the tapered portion 12c and the tapered portion 21 when fitted to each other are not in surface contact but in point contact (line contact), a fitting force is exerted on a fitting portion in a more concentrated manner compared to the case of surface contact. For this reason, the fittability of the tapered portion 12c and the tapered portion 21 is improved, and thus the sealability of the paper lid 1 is improved. Because the tapered portion 12c and the tapered portion 21 are made of a paper material, the tapered portion 12c and the tapered portion 21 are deformed due to fitting, to form a slight planar portion. The planar portion improves the fittability of the tapered portion 12c and the tapered portion 21. Because a fitting length is shorter due to the tapered portion 12c and the tapered portion 21 being in point contact (line contact) compared to where the tapered portion 12c and the tapered portion 21 are tapered forward, the paper lid 1 is simply removed from the container 20.

FIG. 19E illustrates an example where the curl portion 29 is collapsed along the Z-axis to be extended in the X-axis direction of the same drawing. As described above, because the curl portion 29 is flattened and lengthened horizontally, it is possible to reduce the size of places where the tapered portion 12c and the tapered portion 21 are fitted to each other compared to the example of FIG. 19D.

FIG. 19F illustrates an example where the curl portion 29 is collapsed along the X-axis to be extended in the Z-axis direction of the same drawing. As described above, because the curl portion 29 is lengthened vertically, it is possible to increase the size of places where the tapered portion 12c and the tapered portion 21 are fitted to each other compared to the example of FIG. 19D. Where the tapered portion 12c and the tapered portion 21 are tapered reversely to each other and the sizes of fitting parts of the curl portion 29 and the tapered portion 21 are appropriately set, it is possible to realize the paper lid 1 with good usability.

Incidentally, the paper lid 1 of the fourth embodiment and the fifth embodiment may be a paper lid with the holder 30.

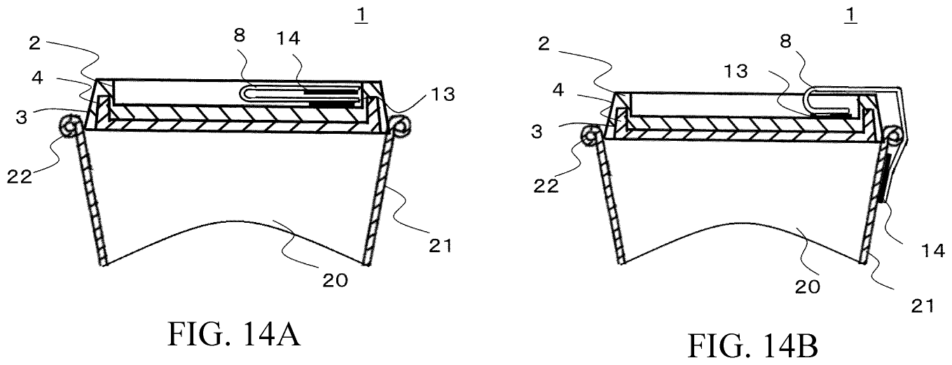

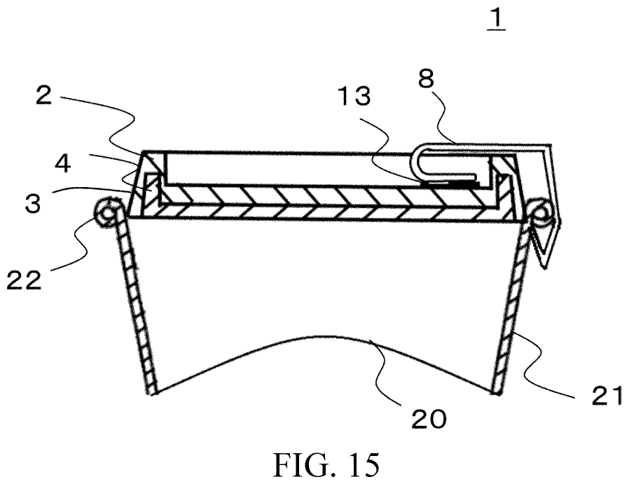

Various modifications can be also made thereto. Hereinafter, modification examples of the seal portion 8 of FIGS. 2A-2D will be described with reference to FIGS. 14A and 14B and FIG. 15. In FIG. 14A, the seal portion 8 is bent into a C-shape, and is joined to the sunken portion of the top lid portion 2 by an adhesive 13 applied to a lower surface side of the seal portion 8. In addition, an adhesive 14 is applied to an upper surface side of the seal portion 8. It is desirable that the adhesive 14 is a releasable adhesive.

FIG. 14B illustrates a mode where one end of an upper surface of the seal portion 8 is pulled and the one end of the upper surface of the seal portion 8 and the tapered portion 21 of the container 20 are joined to each other by the adhesive 14. As described above, because the paper lid 1 and the container 20 are joined to each other using the seal portion 8, it is possible to prevent the paper lid 1 from falling off into the container 20. As illustrated, the adhesive 14 is applied up to an end portion of the upper surface of the seal portion 8; however, it is desirable that the adhesive 14 is applied off from the end portion of the upper surface such that the adhesive 14 does not adhere to a hand. In the present embodiment, the adhesive force of the adhesive 13 is larger than the adhesive force of the adhesive 14. Instead of the foregoing manner or in conjunction therewith, it is preferable that the coating amount of the adhesive 13 is larger than the coating amount of the adhesive 14. The lower surface of the seal portion 8 and the sunken portion of the top lid portion 2 may be joined to each other by heat sealing instead of the adhesive 13.

FIG. 15 illustrates an example where the adhesive 14 of the paper lid 1 in FIGS. 14A and 14B is omitted. Instead of the adhesive 14, the end portion of the upper surface of the seal portion 8 engages with the curl portion 22 to prevent the paper lid 1 from falling off into the container 20. The end portion of the upper surface of the seal portion 8 has a V-shape to engage with the curl portion 22. In order to maintain a V-shape, it is desirable that valleys of the V-shape are joined to each other by various joining methods such as adhesion, heat sealing, ultrasonic joining, and high-frequency joining.

The seal portion 8 of FIGS. 14A and 14B and FIG. 15 may be a seal that covers the drinking spout 5, or may be a seal that is separate from a seal covering the drinking spout 5. Where the drinking spout 5 is covered with the seal portion 8, it is desirable that the adhesive 13 is not provided in a part of the seal portion 8 that is opposite to the drinking spout 5 and on the periphery of the part.

### Seventh Embodiment

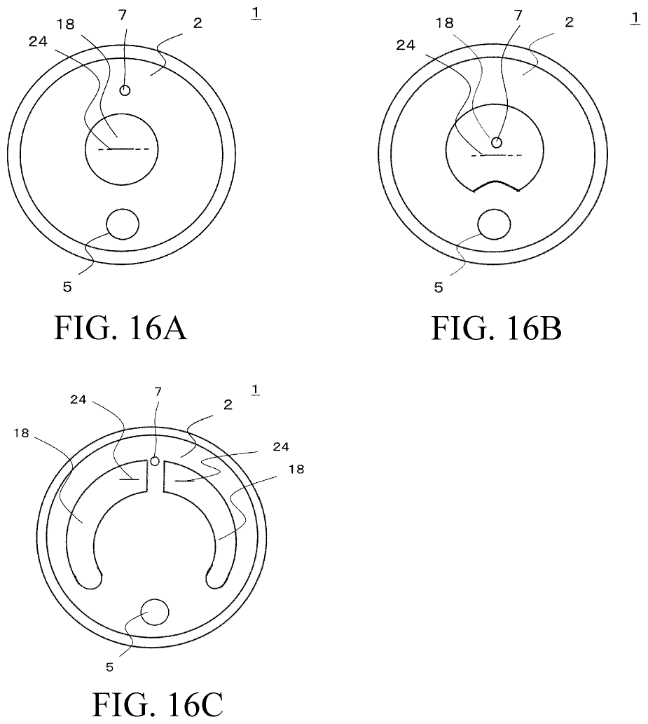

FIGS. 16A-16C are schematic views of the paper lid 1 of a seventh embodiment. To simplify the drawings, the seal portion 8 (see FIGS. 2A-2D) is not illustrated. In the present embodiment, a window portion 18 through which the content of the container 20 is visible, and the window portion 18 is provided with a cut portion 24. The window portion 18 can be formed in the sunken portion of the top lid portion 2.

FIG. 16A illustrates the window portion 18 having a circular shape; however, the shape or the size of the window portion 18 may be any shape or size as long as the content of the container 20 is visible therethrough. In addition, as illustrated in FIG. 16B, the window portion 18 may be shaped to not interfere with the drinking spout 5.

In the present embodiment, the window portion 18 is a transparent member, and can be made of various films (including a biodegradable film) such as a polypropylene film and a polyethylene film. In addition, the transparent member may be made of cellulose nanofibers, and the paper lid 1 may be made of cellulose nanofibers.

The window portion 18 can be formed by forming an opening portion in a paper material, and joining a film as a coating layer to the opening portion to cover the opening portion using various joining methods such as heat sealing and an adhesive. The film may be joined to a single surface side (for example, an upper surface side) of the paper material, or two film rolls are provided and joined to both sides (the upper surface side and a lower surface side). In addition, a film formed by T-die molding where a molten resin is extruded from a slit to form a thin film can be joined to the paper material. In this case, because the molten resin is used, when the paper material and the film are pressed by a pair of pressing rollers, the resin may adhere to a film side pressing roller. For this reason, it is preferable that the film side pressing roller be made of Teflon (registered trademark) or silicon. In addition, the pair of pressing rollers may be heated to improve the joinability between the paper material and the film. Also in this case, in order to avoid the adhesion of the resin to the film side pressing roller, it is preferable that a paper material side pressing roller is heated. The air hole portion 7 may be formed at a position different from that of the window portion 18 as illustrated in FIG. 16A, or may be formed in the window portion 18 as illustrated in FIG. 16B. Where the paper lid 1 is for a cold beverage, the air hole portion 7 may be omitted. In addition, where the paper lid 1 is for a cold beverage, the top lid portion 2 may not be made of a paper material but be made of a film through which the content of the container 20 is visible, and a cut into which a straw is inserted may be formed in the film.

The cut portion 24 is a portion into which a straw is inserted. In the present embodiment, the cut portion 24 includes a cut indicated by a solid line, and half-cuts that are indicated by dotted lines and are formed at both ends of the cut. However, the cut portion 24 may include only the cut or only the half-cuts. Where the paper lid 1 is for a hot beverage, the cut portion 24 may be omitted. The width of the cut portion 24 can be from approximately 0.3 mm to 1 mm. In a state where the film of the window portion 18 is stretched, in a case where a cutter is put in the film, and a cut capable of communicating with the container 20 side is provided, when the cutter is pulled out, the width of the cut becomes narrower due to the elasticity of the film toward the container 20 side. For this reason, in a state where a straw is not yet inserted, even when the paper lid 1 is fitted to the container 20 and the container 20 is turned upside down, there is almost no leakage of the content from the cut portion 24. Even when the container 20 is accidentally overturned, the content does not leak from the paper lid 1. The cut portion 24 may be cross hairs, radial lines, or a curved line (for example, an S-shape).

Because the cut is formed as described above, the straw can be easily inserted into the cut portion 24. Furthermore, because the half-cuts are formed at both ends of the cut, when a straw having a large diameter is inserted, half-cut parts are ruptured. For this reason, straws from a straw having a small diameter to a straw having a large diameter can be easily inserted into the cut portion 24 of the present embodiment.

FIG. 16C illustrates an example where the window portions 18 are provided at two places (a plurality of places), and the cut portions 24 are also provided at two places (a plurality of places). However, the cut portion 24 may be provided at one place. It is possible to improve the visibility by bisymmetrically providing the two window portions 18, and it is possible to improve the visibility by providing the two window portions 18 at positions that are offset from the center of the top lid portion 2.

In the examples of FIGS. 16A-16C, it is desirable that the area of the window portion 18 is from approximately 5% to 50% of the area of the top lid portion 2. Where the size of the window portion 18 is less than 5% of the area of the top lid portion 2, visibility deteriorates. Where the size of the window portion 18 exceeds 50% of the area of the top lid portion 2, the amount film used is increased, which is not preferable from the viewpoint of the environment. Where a biodegradable film is used, the size of the window portion 18 may exceed 50% of the area of the top lid portion 2.

Press working may be performed on the periphery of the window portion 18, in which the cut portion 24 is not formed, to improve the strength of the window portion 18.

Where the display portion 40 or the cut portion 41 described above is provided in conjunction with the formation of the window portion 18, it is possible to more easily see the content of the container 20.

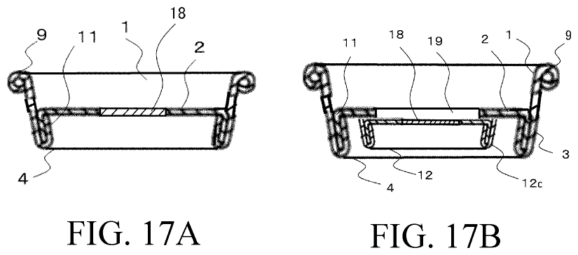

FIGS. 17A and 17B are cross-sectional views of the paper lid 1 of the seventh embodiment. FIG. 17A illustrates a case where the window portion 18 is provided in the paper lid 1 of the fifth embodiment (see FIG. 8A), and FIG. 17B illustrates a case where the window portion 18 is provided in the paper lid 1 of the sixth embodiment (see FIG. 9A). To simplify the drawings, the drinking spout 5 or the cut portion 24 is not illustrated. As illustrated in FIG. 17A, the window portion 18 is formed in the top lid portion 2. Additionally, a film may be stretched on a part (lower portion of the bottom lid portion 4) to serve as the window portion 18. As described above, because two window portions 18 are provided, a space formed by the two films serves as a heat insulating portion; and thereby, it is possible to improve the heat retention of the content in the container 20.

FIG. 17B illustrates an example where the window portion 18 is provided not in the top lid portion 2 but in the engaging portion 12. Because an opening portion 19 is provided in the top lid portion 2, it is realized that the window portion 18 is provided in the engaging portion 12. Instead of the opening portion 19, the window portion 18 may be provided also in the top lid portion 2.

In addition, a film may also be stretched on a part (lower portion of the engaging portion 12) to serve as the window portion 18, and a film may also be stretched on a part (lower portion of the bottom lid portion 4) to serve as the window portion 18. As described above, because two or more window portions 18 are provided, a space formed by the two films serves as a heat insulating portion; and thereby, it is possible to improve the heat retention of the content in container 20.

Incidentally, a curl portion may be formed in an upper surface of the engaging portion 12, and the engaging portion 12 and the bottom lid portion 4 may be joined to each other by the curl portion.

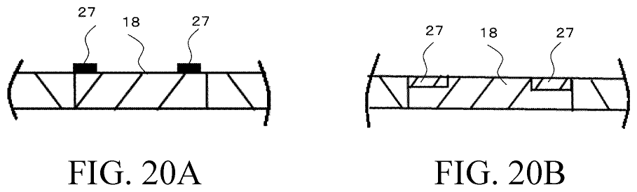

FIGS. 20A and 20B are enlarged cross-sectional views of the window portion 18 of the seventh embodiment. To simplify the drawings, the cut portion 24 is omitted. When the cut portion 24 is formed in the window portion 18, the vicinity of the cut portion 24 becomes weaker compared to other parts. For this reason, in FIG. 20A, a reinforcement portion 27 is formed as a reinforcement for the vicinity of the cut portion 24. An adhesive (for example, a hotmelt) may be applied as the reinforcement portion 27. The adhesive dries and is cured; and thereby, the vicinity of the cut portion 24 can be reinforced.

In FIG. 20B, with regards to the reinforcement portion 27, the density of the film of the window portion 18 is increased by compressing the film. Specifically, the film of the window portion 18 is compressed by heat sealing, ultrasonic joining, high-frequency joining, or crimping. Accordingly, the vicinity of the cut portion 24 can be reinforced.

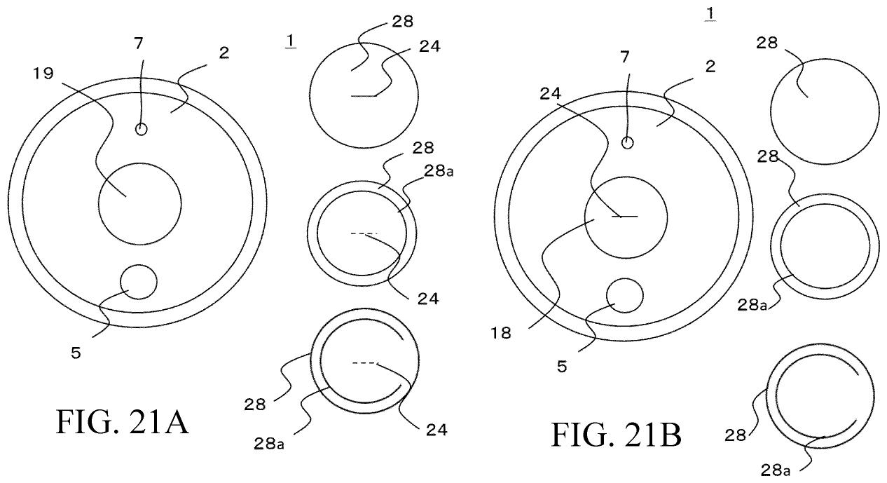

FIGS. 21A and 21B show a modification example of the window portion 18 of the paper lid 1 of the seventh embodiment. In FIG. 21A, the opening portion 19 is formed and the cut portion 24 is not formed in the paper lid 1, and the cut portion 24 is formed as a separate member. The separate member is a second seal portion 28, and three examples are illustrated on the right side of FIG. 21A. The three examples will be described in order from top to bottom.

Any one of the second seal portions 28 can be made of a film, a paper material, aluminum, a non-woven fabric, a rubber, or a cloth. In addition, a second sub-seal portion 28a can be also made of the foregoing materials.

The cut portion 24 is formed at the center of the second seal portion 28 illustrated uppermost in FIG. 21A. The second seal portion 28 has a circular shape as shown; however, as long as the size of the second seal portion 28 is larger than the size of the opening portion 19, the second seal portion 28 may have any shape. A releasable adhesive may be applied to a surface of the second seal portion 28, which is opposite to the opening portion 19, such that the second seal portion 28 is joined to the circumference of the opening portion 19. Alternatively, the second seal portion 28 may be joined to the circumference of the opening portion 19 by heat sealing, ultrasonic joining, or high-frequency joining.

A straw can be inserted through the cut portion 24 in the second seal portion 28.

The second seal portion 28 illustrated in the middle of FIG. 21A has a donut shape. The second sub-seal portion 28a, which is smaller than the second seal portion 28, is formed on the second seal portion 28. The cut portion 24 is formed as described above, and the second seal portion 28 is joined to the circumference of the opening portion 19. A releasable adhesive is applied to the second sub-seal portion 28a, and is joined to the second seal portion 28. Incidentally, where the cut portion 24 is not formed in the second sub-seal portion 28a, this configuration is hygienic because the cut portion 24 of the second seal portion 28 is not exposed. The second sub-seal portion 28a is peeled off from the second seal portion 28, so that a straw can be inserted through the cut portion 24. The cut portion 24 may be formed also in the second sub-seal portion 28a.

As described above, because the second sub-seal portion 28a is provided, the cut portion 24 formed in the second seal portion 28 can be reinforced as in the case of the reinforcement portion 27 described above.

The second seal portion 28 illustrated lowermost in FIG. 21A has a donut shape. The second sub-seal portion 28a, which is smaller than the second seal portion 28, is formed on the second seal portion 28. A part of an outer periphery of the second sub-seal portion 28a is not cut but is integrated with the second seal portion 28. For this reason, the second sub-seal portion 28a is turned over from the second seal portion 28, so that a straw can be inserted through the cut portion 24.

Incidentally, printing may be performed on at least one of the second seal portion 28 or the second sub-seal portion 28a to provide a marker to help finding out an insertion point for a straw.

In addition, it is desirable that the cut portion 24 is shaped and sized so as to be usable with a paper straw or also a straw having a non-sharp tip.

FIG. 21B illustrates an example where the window portion 18 and the cut portion 24 are formed in the paper lid 1 and the cut portion 24 is covered with the second seal portion 28. The size of the second seal portion 28 is larger than the size of the window portion 18; however, the present invention is not limited thereto.

The second seal portion 28 illustrated uppermost in FIG. 21B may be peeled off from the window portion 18 owing to a releasable adhesive. Approximately half of an outer periphery of the second seal portion 28 may be welded to the window portion 18 by heat sealing, and the second seal portion 28 may be turned over.

The second seal portion 28 illustrated in the middle of FIG. 21B has a donut shape, and the second sub-seal portion 28a may be peeled off from the second seal portion 28 owing to a releasable adhesive. Approximately half of the outer periphery of the second sub-seal portion 28a may be welded to the second seal portion 28 by heat sealing, and the second sub-seal portion 28a may be turned over. The cut portion 24 may be formed or an opening portion may be formed in the second seal portion 28 to correspond to the cut portion 24 of the window portion 18.

The second seal portion 28 illustrated lowermost in FIG. 21B has a donut shape. The second sub-seal portion 28a, which is smaller than the second seal portion 28, is formed on the second seal portion 28. A part of an outer periphery of the second sub-seal portion 28a is not cut but is integrated with the second seal portion 28. The cut portion 24 or an opening portion may be formed in the second seal portion 28 to correspond to the cut portion 24 of the window portion 18.

For this reason, the second sub-seal portion 28a is turned over from the second seal portion 28, so that a straw can be inserted through the cut portion 24. Incidentally, the second seal portion 28 of FIGS. 21A and 21B may include two sheets of seal portions (for example, a semicircular shape or a rectangular shape), and parts of the seal portions may overlap each other by approximately several millimeters. One end of the second seal portion 28 may be bent upward and pulled up with fingers.

### Eighth Embodiment

FIG. 22A is a cross-sectional view of the paper lid 1 of an eighth embodiment, and is illustrated together with a partial enlarged view. In the present embodiment, a recessed portion 35 is formed in the sunken portion of the top lid portion 2. An engaging portion 36, which engages with the curl portion 22, is joined to the top lid portion 2. The second tapered portion 11 is pressed excluding a part thereof, and as a result, a protruding portion 37 having a circumferential shape is formed. Incidentally, in the drawing, the thickness (in a rightward and leftward direction) of the protruding portion 37 is illustrated as being small; however, because the thickness of the protruding portion 37 is thicker than the thickness of the paper material of the top lid portion 2 or the second tapered portion 11, it is possible to further improve the sealability between the paper lid 1 and the container 20.

Incidentally, the drawing is simplified, and the curl portion 9 and the curl portion 22 are outward curls. To simplify the drawing, the drinking spout 5 is not illustrated.

As one example of the dimensions of the paper lid 1, the diameter is from approximately 70 mm to 140 mm, an entire height H1 of the paper lid 1 is from 12 mm to 20 mm, and the height H2 of a peripheral wall from the curl portion 9 to the top lid portion 2 is from 3.5 mm to 12 mm. The height H2 of the peripheral wall depends on the capacity of the paper lid 1; however, from the viewpoint of the ease of drinking, it is preferable that the height H2 is from 6 mm to 9 mm. Where the height H2 is from approximately 36% to 53% of the entire height H1, it is possible to obtain the paper lid 1 that is well balanced. Incidentally, when transporting a plurality of the paper lids 1 in a stacking manner, the curl portion 9 and the curl portion 9 may perfectly stick to each other, making it difficult to take out the paper lid 1. For this reason, it is desirable that a height obtained by subtracting the height H2 of the peripheral wall from the entire height H1 is larger than the height H2 of the peripheral wall. It is more preferable that the height H2 of the peripheral wall be set from approximately 36% to 48% of the entire height H1. Accordingly, it is easy to take out the plurality of paper lids 1 when stacked, and the stacking height can be reduced.

Desirably, the diameter of the curl portion 9 is from approximately 2 mm to 3 mm and a height obtained by subtracting the diameter of the curl portion 9 from the height H2 of the peripheral wall is larger than the diameter (height) of the curl portion. Accordingly, even when the user puts their mouth on the curl portion 9 to sip a hot beverage from the drinking spout 5, it is possible to reduce the risk of a burn because the temperature of the content decreases according to the height H2 of the peripheral wall. As described with reference to FIG. 25A, because the length L2 from the outer peripheral end (peripheral wall part) to the drinking spout 5 is from 1 mm to 15 mm, preferably from 4 mm to 12 mm, where a sum of the length L2 to the drinking spout 5 and the height H2 of the peripheral wall is set to be from 4.5 mm to 27 mm, preferably from 15 mm to 25 mm, and because the content is ingested via the peripheral wall, it is possible to further reduce the risk of a burn. Incidentally, the dimensions of the paper lid 1 look different on the drawings; however, the foregoing dimensions of the paper lid 1 can be applied also to the fourth to seventh embodiments. The basis weight of the paper lid 1 of the present embodiment may be less than from 150 g/m² to 300 g/m², preferably from approximately 200 g/m² to 250 g/m². Because the basis weight is set in such a small range, when the paper lid 1 is mounted on the container 20, there is no deformation or damage to the curl portion 22 of the container 20. The basis weights of the top lid portion 2 and the second tapered portion 11 may be the same or different from each other; however, even when the basis weights are the same, it is desirable that the thickness of the top lid portion 2 be increased to reduce the density and thus soften the top lid portion 2. When a hot beverage is put in the container 20 and the paper lid 1 is fitted to the container 20, the top lid portion 2 is deformed into a protruding shape due to vapor. Because the curl portion 9 is deformed inward according to the deformation of the top lid portion 2, the sealability between the paper lid 1 and the container 20 is improved.

The recessed portion 35 of the top lid portion 2 can be formed by, for example, press working, and it is desirable that the depth of the recessed portion 35 be from approximately 0.8 mm to 2.0 mm. In addition, the width of the recessed portion 35 is preferably set such that at least an upper portion of the curl portion 22 can be accommodated at both ends of the top lid portion 2. The width of the recessed portion 35 may be slightly smaller than the width of the curl portion 22 and both ends of the top lid portion 2 may be elastically deformed to accommodate at least the upper portion of the curl portion 22. Where both ends of the top lid portion 2 accommodate at least the upper portion of the curl portion 22, the sealability between the paper lid 1 and the container 20 is improved.

To facilitate the formation of the recessed portion 35, the paper material (or paper lid 1) is desirably heated up to a temperature (for example, from 50° C. to 100° C.), at which the coating agent of the paper material is not adversely affected, by infrared rays or hot air. In addition, the lower die of the press machine, which holds the paper material (or the paper lid 1), is preferably heated to 60° C. to 130° C., and more preferably to 70° C. to 100° C. Only either one of the heating of the paper material (or the paper lid 1) and the heating of the press machine may be performed, or both may be performed. Because the recessed portion 35 is formed, as illustrated in the partial enlarged view, a space between the second tapered portion 11 and the recessed portion 35 is reduced. As a result, when the paper lid 1 is mounted on the container 20, the sealability is improved. The recessed portion 35 may be formed such that an end portion of the recessed portion 35 comes into contact with the curl portion 22. The recessed portion 35 may be formed by performing press working on a part corresponding to the recessed portion 35, or may be formed by turning the paper lid 1 upside down and performing press working on both ends of the top lid portion 2.

The engaging portion 36 is a ring-shaped (donut-shaped) member that is made of a paper material provided with a coating layer such as a film, and is joined to an inside of the top lid portion 2 by, for example, heat sealing or ultrasonic joining. Both ends of the engaging portion 36 are free ends that are not joined to the top lid portion 2. Both ends of the engaging portion 36 may have a tapered shape, may be forward tapers having the same taper direction as that of the tapered portion 21, or may be reverse tapers having a taper direction different from that of the tapered portion 21.

The engaging portion 36 has dimensions that allow an engagement with the curl portion 22, and the free ends of the engaging portion 36 are bent upward (not illustrated) by engagement of the free ends with the curl portion 22. Because the engaging portion 36 serves as a packing, when the paper lid 1 is mounted on the container 20 it is possible to improve the sealability. Preferably, the basis weight of the engaging portion 36 is equal to the basis weight of the paper lid 1 or less, and the basis weight of the engaging portion 36 may be from approximately 150 g/m² to 250 g/m².

Because the engaging portion 36 has a ring shape, a space is formed inside the engaging portion 36 that serves as a heat insulating portion; and thereby, it is possible to improve the heat retention of the content in the container 20. In addition, when the container 20 is inclined, a space portion S1 formed by the curl portion 22, the top lid portion 2, and the engaging portion 36 is capable of holding the content from the container 20. Thereby, it is possible to reduce leakage of the content from the paper lid 1 excluding the drinking spout 5. The engaging portion 36 may not have a ring shape but have a solid shape. Various corrugated cardboards having flutes may be used as the paper material, and instead of the paper material, a film (for example, a polyethylene film) may be used.

A piece member of which a part is recessed is pressed, so that the inner peripheral surface of the second tapered portion 11 is compressed. A part that is not pressed by the recessed part of the piece member remains as the protruding portion 37. The curl portion 22 goes over the protruding portion 37 to enter the space formed by the second tapered portion 11 and the recessed portion 35. The protruding portion 37 serves to prevent fall-out of the curl portion 22, which has entered the space formed by the second tapered portion 11 and the recessed portion 35. A plurality of the protruding portions 37 may be provided in the inner peripheral surface of the second tapered portion. For example, two protruding portions 37 may be formed spaced apart from each other in an upward and downward direction, and the curl portion 22 may be fitted between the two protruding portions 37. In this case, a gap between the two protruding portions 37 is narrower than the diameter of the curl portion 22, so that the curl portion 22 is collapsed (modified) and the paper lid 1 is fitted to the container 20. Thereby, it is possible to improve the sealability between the paper lid 1 and the container 20. Incidentally, the protruding portion 37 may not be continuous but be provided intermittently on an inner periphery of the second tapered portion 11. In addition, the shape of the protruding portion 37 may be any shape such as a rectangular shape, a semicircular shape, or an oval shape; however, from the viewpoint of sealability, it is preferable that the shape of a part of the protruding portion 37 is the same as the shape of the curl portion 22. For example, it is preferable that the shape of the part of the protruding portion 37, which engages with the curl portion 22, is the same circumferential shape as that of the curl portion 22.

FIGS. 22B-22D are enlarged views of a mode where a film is used as the engaging portion 36 and hereinafter, descriptions will be given in order. FIG. 22B illustrates a case where when the paper lid 1 is mounted on the container 20, the curl portion 22 goes over the free end of the engaging portion 36. Also, because the space portion S1 formed by the curl portion 22, the top lid portion 2, and the engaging portion 36 is capable of holding the content from the container 20, it is possible to reduce a leakage of the content from the paper lid 1 excluding the drinking spout 5. In FIG. 22(b), the foregoing paper material provided with a coating layer such as a film may be used as the engaging portion 36. In this case, the shapes of both ends of the engaging portion 36 may be bent at the right angle, may be bent at an acute angle, or may be bent at an obtuse angle. Accordingly, a gap between the second tapered portion 11 and an end portion of the engaging portion 36 can be further reduced. Particularly, where shapes of both ends of the engaging portion 36 have an obtuse angle as illustrated in FIG. 22, it is possible to further improve the sealability between the paper lid 1 and the container 20.

FIG. 22C illustrates a case where the end portion of the engaging portion 36 is not a free end and is joined to a side surface of the second tapered portion 11. The center and the periphery of the engaging portion 36 are joined to the top lid portion 2, and a part between the part joined to the top lid portion 2 and the part joined to the side surface of the second tapered portion 11 is not joined to any places. When the paper lid 1 is mounted on the container 20, the curl portion 22 comes into contact with the part that is not joined to any places, and the film forming the engaging portion 36 is elastically deformed toward the paper lid 1, so that the paper lid 1 and the container 20 are fitted to each other. For this reason, even when the container 20 is inclined, there is no leakage of the content from the paper lid 1 excluding the drinking spout 5 because the film forming the engaging portion 36 acts to prevent a leakage of the content from the container 20.

The space portion S1 is formed by the top lid portion 2, the second tapered portion 11, the engaging portion 36, and the curl portion 22. For example, even when the container 20 made of a paper is strongly grasped with the hand and thus the container 20 is deformed, the paper lid 1 is less likely to be removed from the container 20 because the space portion S1 follows the deformation or serves as a cushion.

FIG. 22D illustrates a case where the engaging portion 36 is not joined to the top lid portion 2 and both ends of the engaging portion 36 are joined to the side surface of the second tapered portion 11. When the paper lid 1 is mounted on the container 20, the film forming the engaging portion 36 is elastically deformed toward the paper lid 1, so that the paper lid 1 and the container 20 are fitted to each other. For this reason, even when the container 20 is inclined, there is no leakage of the content from the paper lid 1 excluding the drinking spout 5 because the film forming the engaging portion 36 acts to prevent a leakage of the content from the container 20.

The foregoing paper material provided with a coating layer such as a film may be used as the engaging portion 36. In this case, it is preferable that the engaging portion 36 has a solid shape and the engaging portion 36 is joined to the top lid portion 2. The flatness of the top lid portion 2 may be deteriorated by a process of producing the top lid portion 2, and there is a risk of the occurrence of a leakage of the content from the top lid portion 2 and the curl portion 22 due to a deterioration in the flatness of the top lid portion 2. For this reason, it is possible to reduce the risk of the occurrence of the foregoing leakage by causing the curl portion 22 to engage with the engaging portion 36 of which the flatness is maintained.

The shape of the engaging portion 36 may be a ring shape.

The foregoing various joining methods can be applied as a method for joining the engaging portion 36. In addition, films other than a polyethylene film can be also used as the film. A paper material or another material, such as an air-laid material where crushed pulps are laminated together, may be also joined to the film as long as the film is elastically deformable.

In FIGS. 22B-22D, the recessed portion 35 and the protruding portion 37 may be formed or may be omitted. When the recessed portion 35 is formed, a part of the engaging portion 36 may be joined to the recessed portion 35.

In FIGS. 22A-22D, where the content of the container 20 is a hot beverage such as a hot coffee, because the pressure of a space sealed by the paper lid 1 and the container 20 becomes high, the adhesion of the film forming the engaging portion 36 is improved. Accordingly, it is possible to improve the sealability between the paper lid 1 and the container 20.

FIGS. 22E-22G are modification examples where a paper material provided with a coating layer such as a film is used as the engaging portion 36. Hereinafter, descriptions will be given in order. In FIG. 22E, the end portion of the engaging portion 36 is formed by press working to substantially cover the outside of the curl portion 22. Contact surfaces of the recessed portion 35 and the engaging portion 36 are joined to each other. The end portion of the engaging portion 36 may be a free end, or may be joined to the second tapered portion 11. Where the end portion of the engaging portion 36 is a free end, the dimensions of the end portion of the engaging portion 36 may be set such that the free end of the engaging portion 36 engages with the curl portion 22 to be bent upward.

Where a bottom part of a paper cup is used as the paper lid 1, there is a risk that a seam of the paper material and the paper material is formed on the inside of the peripheral wall of the paper lid 1 and the content of the container 20 leaks from the seam. However, a part of the seam on the inside of the peripheral wall of the paper lid 1 can be pressed and sealed by the end portion of the engaging portion 36. For this reason, it is possible to prevent the content from leaking from the paper lid 1 along the seam. Accordingly, even when the container 20 is inclined, there is no leakage of the content from the paper lid 1 excluding the drinking spout 5 because the engaging portion 36 covers the outside of the curl portion 22. In addition, because the space portion S1 is formed by the top lid portion 2, the second tapered portion 11, the engaging portion 36, and the curl portion 22, even when the container 20 made of a paper is strongly grasped with the hand and thus the container 20 is deformed, the space portion S1 follows the deformation or serves as a cushion owing to the elasticity of the space portion S1. Thereby, the paper lid 1 is less likely to be removed from the container 20.

Where the drinking spout 5 is formed in a part of the seam on the inside of the peripheral wall of the paper lid 1, the content leaks from the seam. For this reason, it is desirable that the drinking spout 5 is provided at a position different from that of the seam on the inside of the peripheral wall of the paper lid 1 (a position where there is no interference therebetween).

Where the engaging portion 36 of FIG. 22E is made of a film and the engaging portion 36 engages with the curl portion 22 using the elasticity of the film, the adhesion between the engaging portion 36 and the curl portion 22 is further improved.

In FIG. 22F, an end portion of the engaging portion 36, which includes a protruding portion 36a and a recessed portion 36b, is formed by press working to substantially cover the outside and the inside of the curl portion 22. As described above, when a part of the seam on the inside of the peripheral wall of the paper lid 1 is pressed and sealed by the end portion of the engaging portion 36, it is possible to prevent the content from leaking from the paper lid 1 along the seam. Furthermore, a part of the seam formed on an inside of a peripheral wall of the container 20 can be pressed and sealed by the recessed portion 36b of the engaging portion 36. For this reason, it is possible to prevent the content from leaking from the paper lid 1 along the seam on the inside of the peripheral wall of the container 20.

Accordingly, even when the container 20 is inclined, there is no leakage of the content from the paper lid 1 excluding the drinking spout 5 because the engaging portion 36 covers the outside and the inside of the curl portion 22. The drinking spout 5 may be provided in a part where the recessed portion 35 and the engaging portion 36 are in contact with each other.

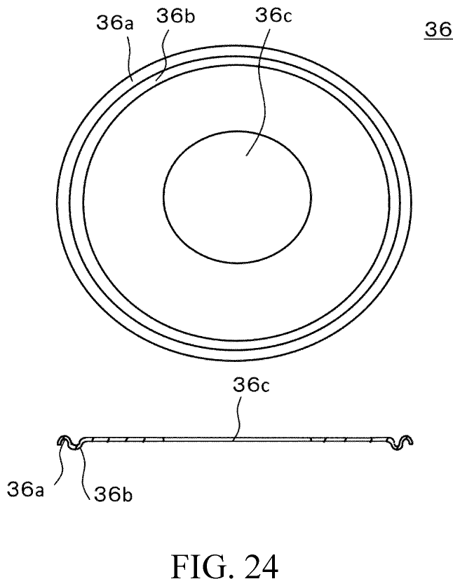

FIG. 24 is a schematic view and a cross-sectional view illustrating one example of the engaging portion 36 of FIG. 22F. As illustrated in FIG. 24, the engaging portion 36 has a circular shape. The engaging portion 36 has the protruding portion 36a, which is a first part, the recessed portion 36b, which is a second part, and an opening portion 36c. The outer diameter of the engaging portion 36 is larger than the outer diameter of the bottom lid portion 4. For this reason, when the engaging portion 36 is fitted to the top lid portion 2, the end portion of the engaging portion 36 may be bent toward the container 20 side. Accordingly, the sealability between the paper lid 1 and the container 20 is improved. Where the outer diameter of the engaging portion 36 is larger than the outer diameter of the bottom lid portion 4 and the engaging portion 36 is fitted to the top lid portion 2, the joining of the top lid portion 2 and the engaging portion 36 by heat sealing may be omitted.

The thickness of the engaging portion 36 excluding the protruding portion 36a and the recessed portion 36b is from approximately 0.7 mm to 2.0 mm. Where the thickness of the engaging portion 36 is set as described above, the strength of the top lid portion 2 or the recessed portion 35 is improved, and the flatness of the top lid portion 2 or the recessed portion 35 is improved. In addition, spring properties (elasticity) can be given to the protruding portion 36a, and the protruding portion 36a can follow a deformation of the curl portion 22. Incidentally, the protruding portion 36a has a semicircular shape to engage with the curl portion 22; however, the protruding portion 36a may have an inverted U-shape or an inverted V-shape. As another example of a manner where the protruding portion 36a engages with the curl portion 22, the size (size of a semicircular shape) of the protruding portion 36a may be set smaller than the size (diameter) of the curl portion 22, and the curl portion 22 may be deformed, so that the curl portion 22 engages with the protruding portion 36a. The recessed portion 36b may have a linear shape.

The protruding portion 36a and the recessed portion 36b are formed by press working as described above. The protruding portion 36a is shaped to cover the outside of the curl portion 22, and the recessed portion 36b is shaped to cover the outside of the curl portion 22. That is, the protruding portion 36a and the recessed portion 36b are shaped to cover the curl portion 22. The protruding portion 36a and the recessed portion 36b may not cover all of the curl portion 22.

As described above, the engaging portion 36 is made of a paper material provided with a coating layer such as a film. The press working for forming the protruding portion 36a and the recessed portion 36b may be performed in a state where the film is joined to the paper material, or after the press working, the film may be stretched. When the protruding portion 36a is formed and then the film on a surface of the protruding portion 36a, which is opposite to the curl portion 22, is stretched, the protruding portion 36a is capable of engaging with the outside of the curl portion 22 using the elasticity of the film.

The opening portion 36c is an opening for positioning to join the engaging portion 36 to the recessed portion 35, and the size of the opening portion 36c can be appropriately set. The opening portion 36c may be omitted, and the positioning of the engaging portion 36 to be joined to the recessed portion 35 may be performed using an outer periphery of the engaging portion 36, or a notch may be formed in the engaging portion 36 to perform the positioning of the engaging portion 36 to be joined to the recessed portion 35.

FIG. 22G is an example corresponding to FIG. 22A, where the protruding portion 37 is omitted, and a paper material having elasticity (cushioning properties) is used as the paper material of the engaging portion 36. A coating layer such as a film is provided on at least a single surface (surface opposite to the container 20) of the paper material having elasticity. Various corrugated cardboards can be used as the paper material having elasticity. Corrugated cardboard is good in cushion properties and rigidity owing to flutes; however, an end portion of corrugated cardboard has weak rigidity and is prone to be elastically deformed. When corrugated cardboard is used as the paper material of the engaging portion 36, it is possible to improve the sealability between the paper lid 1 and the container 20 because the end portion of the corrugated cardboard engages with the curl portion 22 to be elastically deformed.

As the paper material having elasticity, a paper material and a foamed polyethylene may be laminated together, or a soft paper material subjected to embossing or an air-laid material may be laminated. In this case, it is preferable that a coating layer such as a film is provided on or a waterproof agent is applied to at least a single surface (e.g., the surface opposite to the container 20) of the paper material. In addition, the paper material having elasticity may be laminated between layers of paper material. Instead of the paper material having elasticity, various non-woven fabrics may be used.

The air-laid material may be heat-sealed with a film instead of being laminated with a paper material, so that a heat-sealed surface of the air-laid material is sealed by heat treatment. As described above, the engaging portion 36 may be configured to include a coating layer (waterproof layer) and an elastic layer.

In addition, the paper material having elasticity may be formed by laminating a plurality of thin papers and providing coating layers on the laminated thin papers.

The free end of the engaging portion 36 of FIG. 22G may have a tapered shape, may be a forward taper having the same taper direction as that of the tapered portion 21, or may be a reverse taper having a taper direction different from that of the tapered portion 21.

Dimensions of the end portion of the engaging portion 36 may be set such that the free end of the engaging portion 36 engages with the curl portion 22 to be bent upward (toward the space portion S1).

The gap between the second tapered portion 11 and the end portion of the engaging portion 36 may be smaller than the size of the curl portion 22, and the curl portion 22 may be deformed, so that the curl portion 22 engages between the second tapered portion 11 and the end portion of the engaging portion 36.

In FIGS. 22E 4-22G, the protruding portion 37 may be provided in the second tapered portion 11, and the recessed portion 35 may be omitted. In the examples of FIGS. 22C, 22E, and 22F, where the protruding portion 37 is provided in the second tapered portion 11, it is desirable that the end portion of the engaging portion 36 is shaped to cover the protruding portion 37. Accordingly, the content of the container 20 is less likely to leak from the paper lid 1.

In addition, in FIGS. 22A-22G, where the taper angle of the second tapered portion 11 is more acute than the taper angle of the tapered portion 21 of the container 20, it is possible to further increase the volume of the space portion S1. Accordingly, even when the container 20 is deformed, the paper lid 1 is less likely to be removed from the container 20.

Instead of the engaging portion 36, an elastic member may be provided on a curl portion 22 side of the top lid portion 2 or on the inner peripheral surface of the second tapered portion 11 to engage with the curl portion 22. A film, a rubber, a foamed polyethylene, a polyurethane, a silicone, or a hotmelt can be used as the elastic member.

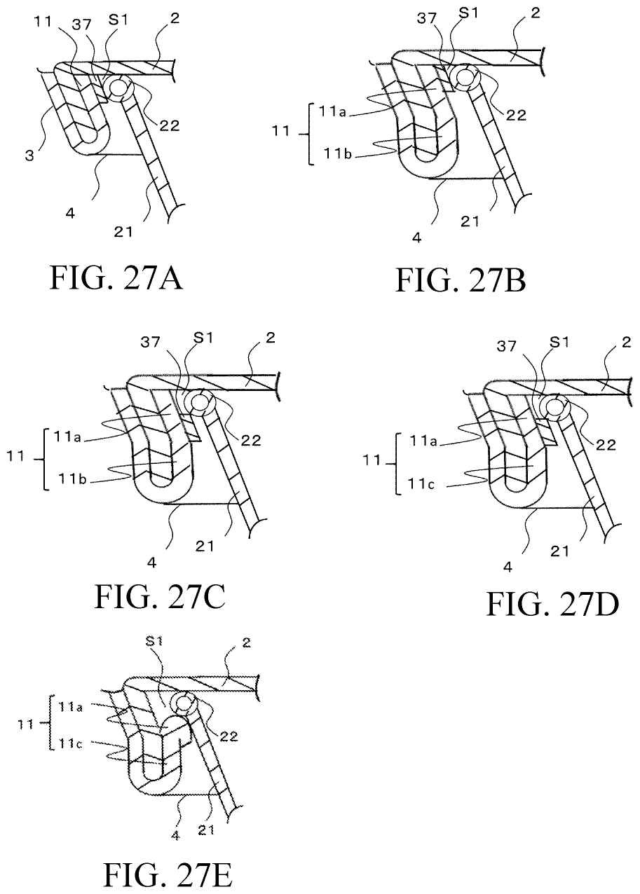

FIGS. 27A-27E also illustrate five other examples of cross-sectional views of the paper lid 1 of the eighth embodiment. Hereinafter, the examples of FIGS. 27A-27E will be sequentially described. In the five examples, the recessed portion 35 and the engaging portion 36 are omitted; however, the recessed portion 35 and the engaging portion 36 may be provided.

FIG. 27A illustrates an example where the protruding portion 37, which has a circumferential shape and is provided on the inner periphery of the second tapered portion 11, is fitted to the curl portion 22. In this case, the inner diameter of a tip of the protruding portion 37 that the curl portion 22 enters is smaller than the outer diameter of the curl portion 22, so that at least one of the curl portion 22 or the protruding portion 37 is deformed to allow the curl portion 22 and the protruding portion 37 to be fitted to each other. Thereby, it is possible to improve the sealability between the paper lid 1 and the container 20.

FIG. 27B illustrates an example where the second tapered portion 11 is formed at a plurality of different taper angles. For example, the taper angle of a strong tapered portion 11a is 5°, and the taper angle is stronger (larger) than that of a weak tapered portion 11b to be described later. The weak tapered portion 11b is provided closer to the container 20 side (curl portion 22 side) than the strong tapered portion 11a. For example, the taper angle of the weak tapered portion 11b is 3°, and the taper angle is weaker (smaller) than that of the strong tapered portion 11a. Because the taper angle on the container 20 side (curl portion 22 side) is set to be weak (small), the curl portion 22 easily enters the paper lid 1. Where the taper of the weak tapered portion 11b has a tapered shape (tapered shape that is widened outward) reverse to that of the strong tapered portion 11a, the curl portion 22 enters the paper lid 1 more easily.

In FIGS. 27A and 27B, the dimension of the protruding portion 37 in the Z direction (height direction) may be half the diameter of the curl portion 22 or larger, and is preferably equal to the diameter of the curl portion 22 or larger. Thereby, it is possible to improve the sealability between the paper lid 1 and the container 20.

FIG. 27C illustrates an example where the protruding portion 37 is provided on a lower side of the strong tapered portion 11a. Accordingly, when the paper lid is fitted to the container 20, the curl portion 22 goes over the protruding portion 37. Thereby, the user can feel the sense of a notch, and tactilely feel that the paper lid 1 is closed.

FIG. 27D illustrates an example where the protruding portion 37 is provided on the lower side of the strong tapered portion 11a. Further, instead of the weak tapered portion 11b, a linear portion 11c is provided. Because the curl portion 22 easily enters the paper lid 1 owing to the linear portion 11c, the user can simply mount the paper lid 1 on the container 20. A seam of the strong tapered portion 11a and the weak tapered portion 11b or a seam of the strong tapered portion 11a and the linear portion 11c may be linear or curved.

FIG. 27E illustrates an example where instead of the protruding portion 37 being provided, a tip of the strong tapered portion 11a is bent inward. Accordingly, the space portion S1 can be widened compared to the other examples; and thereby, the space portion S1 is capable of holding the content. In addition, because the curl portion 22 goes over an inward bent part of the tip of the strong tapered portion 11a, it is possible to secure the sense of a notch, and it is possible to secure the sealability between the paper lid 1 and the container 20. Incidentally, also in FIGS. 27A-27D, the protruding portion 37 may be omitted, and the tip of the second tapered portion 11 or the tip of the strong tapered portion 11a may be bent inward.

The protruding portion 37 is not limited to a case where the protruding portion 37 is formed by attaching a separate member. The protruding portion 37 may be integrally formed on the inside of the tapered portion by a molding device including a piece member to be described later.

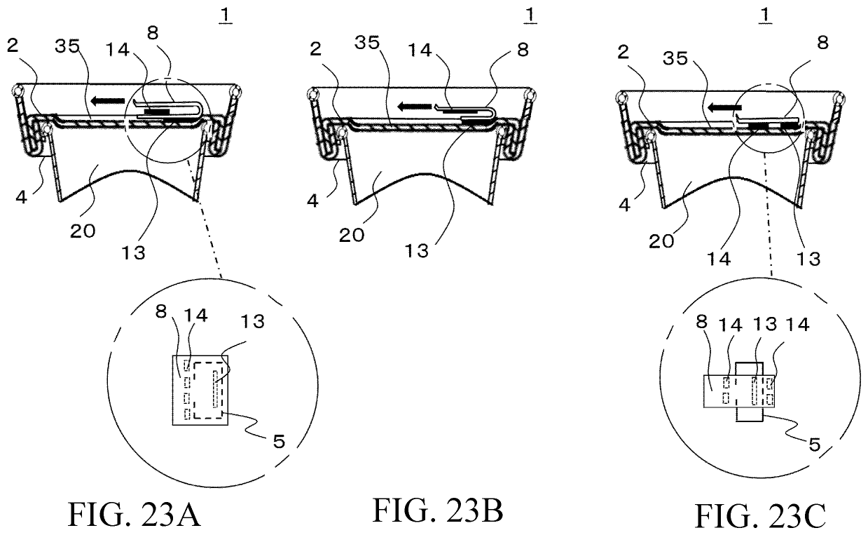

FIGS. 23A-23C are cross-sectional views illustrating the seal portion 8 of the paper lid 1 of the eighth embodiment. Three examples of the seal portion 8 of the paper lid 1 are illustrated in FIGS. 23A-23C, which will be sequentially described hereinafter. Paper lids 1 other than that of the eighth embodiment may be used as the paper lid 1.

FIG. 23A illustrates the seal portion 8 that seals the drinking spout 5 formed in the recessed portion 35 of the top lid portion 2. A view where the drinking spout 5 is seen from above is illustrated below. The drinking spout 5 has the same shape as that illustrated in FIG. 2C. A cut is provided in the recessed portion 35 and the drinking spout 5 is opened in an arrow direction of the paper lid 1. The seal portion 8 is sized to cover the drinking spout 5; however, the seal portion 8 may be sized to cover a part of the drinking spout 5. Incidentally, it is difficult to see the drinking spout 5, and thus characters or pictures indicating the location of the drinking spout 5 may be printed on the seal portion 8.

The seal portion 8 has an inverted C-shape, and the lower surface of the seal portion 8 and the recessed portion 35 are joined to each other by the adhesive 13 that is provided to correspond to an upper surface of the drinking spout 5. A tip of a free end of the seal portion 8 extends upward to serve as a pull-up portion of the seal portion 8.

The adhesive 14, which is releasable, is dispersedly applied to a surface of the seal portion 8 that is opposite to the lower surface of the seal portion 8 to which the adhesive 13 is applied. The adhesive 14 may be applied to a plurality of places in a dot pattern, may be applied in a spiral pattern, or may be continuously applied. When the pull-up portion is pulled in the direction indicated by an arrow in FIG. 23A, a part of the drinking spout 5 in which the cut is not formed serves as a hinge, and the drinking spout 5 is opened. Furthermore, when the seal portion 8 is pulled in the arrow direction, the shape of the seal portion 8 is changed from an inverted C-shape to a linear shape, and the adhesive 14 becomes opposite to the recessed portion 35. In this state, the adhesive 14 is pressed against the recessed portion 35, so that an open state of the drinking spout 5 can be held.

FIG. 23B illustrates an example where the position of application of the adhesive 14, which is releasable, is different from that in FIG. 23A. Namely, the adhesive 14 is applied to a back surface of an upper portion of an inverted C-shape. When the pull-up portion is pulled in a direction indicated by an arrow in FIG. 23B, the drinking spout 5 is opened, the shape of the seal portion 8 is changed from an inverted C-shape to a linear shape. The adhesive 14 becomes opposite to the recessed portion 35. In this state, the adhesive 14 is pressed against the recessed portion 35, so that an open state of the drinking spout 5 can be held.

FIG. 23C illustrates an example where the seal portion 8 has a linear shape and the adhesive 13 and the adhesive 14, which is releasable, are applied to the lower surface of the seal portion 8, which is a surface opposite to the recessed portion 35. The adhesive 13 corresponds to the upper surface of the drinking spout 5. In this case, the adhesive 14 may be applied to be joined to the recessed portion 35, or may be applied to not be joined to the recessed portion 35. When the adhesive 14 is joined to the recessed portion 35, it is preferable that a release paper is affixed to the recessed portion 35 to be joined to the adhesive 14 or a release agent such as a silicon or Teflon (registered trademark) is applied to the recessed portion 35. It is preferable that the release paper is provided to not interfere with at least a part (drinking spout 5 side) of the adhesive 13.

As illustrated in an enlarged view of FIG. 23C, the seal portion 8 is shaped to cover a part of the drinking spout 5, and the adhesive 14 is provided at two places to interpose the drinking spout 5 therebetween. As described above, the adhesive 14 is provided also between the drinking spout 5 and the peripheral wall. Thereby, it is possible to confirm whether or not the drinking spout 5 is open.

After the pull-up portion is pulled in a direction indicated by an arrow in FIG. 23C to open the drinking spout 5, the adhesive 14 provided close to the center, which is releasable, is pressed against the recessed portion 35 from the center. As a result, an open state of the drinking spout 5 can be held.

In the present embodiment, the adhesive force of the adhesive 13 is larger than the adhesive force of the adhesive 14. Instead of the foregoing manner or in conjunction therewith, it is preferable that the coating amount of the adhesive 13 is larger than the coating amount of the adhesive 14. An adhesive may be applied to the entirety of the back surface of the seal portion 8 and a wax may be applied to the pull-up portion or a part where the adhesive force is to be weak to cancel out the adhesive force of the adhesive. In this case, it is possible to appropriately reduce the coating amount of the adhesive or increase the coating amount of the wax with respect to the pull-up portion or the part where the adhesive force is to be weak. The lower surface of the seal portion 8 and the recessed portion 35 may be joined to each other by heat sealing instead of the adhesive 13. The seal portion 8 may be formed as a Z-fold. The recessed portion 35 may not be formed, and the top lid portion 2 may be flat.

In regards to the size of the drinking spout 5 illustrated in FIGS. 2A-2D and 23A-23C, where the drinking spout 5 has a circular shape, the diameter may be from approximately 6 mm to 14 mm. Where the drinking spout 5 has a rectangular shape, the length of a diagonal line may be from approximately 9 mm to 20 mm. Accordingly, large ice does not pass through the drinking spout 5, so that children can be prevented from accidentally swallowing large ice.

Method for Producing Paper Lid

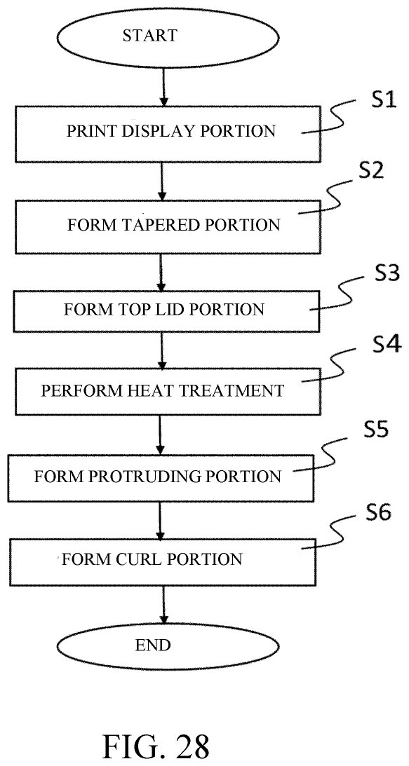

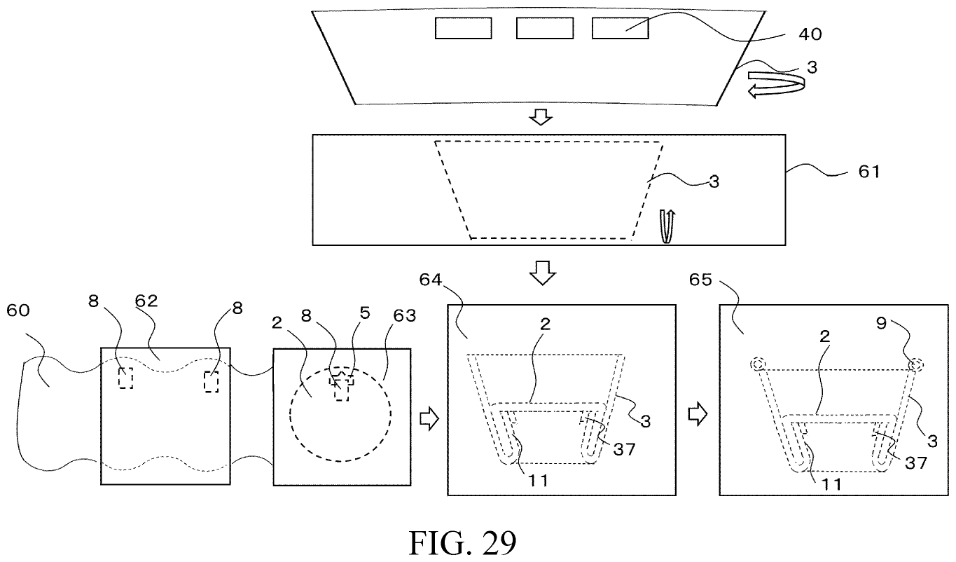

FIG. 28 is a flowchart illustrating one example of a method for producing the paper lid 1, and FIG. 29 is a schematic view of the method for producing the paper lid 1. Hereinafter, the method for producing the paper lid 1 will be described using the paper lid 1 illustrated in FIG. 27A as an example.

A material (referred to as a fan-shaped paper material including a coating layer) forming the tapered portion 3 of the paper lid 1 is mold cut into a fan shape as illustrated in FIG. 26. In this state, the printing of the display portion 40 is performed (step S1). The printing of the display portion 40 may be performed before the material is mold cut into a fan shape. The display portion 40 may be printed on the paper material, or may be printed on a film that is a coating layer. The number of display portions 40 is not limited to three. It is desirable that a cut of the cut portion 41 is formed subsequent to the printing of the display portion 40.

The fan-shaped paper material including a coating layer is transported to a first processing station 61. In the first processing station 61, in a state where both ends of the fan shape of the fan-shaped paper material including a coating layer partially overlap each other, both ends are joined to each other by, for example, ultrasonic joining. Accordingly, the tapered portion 3 is formed (step S2). In this case, the tapered portion 3 is formed using a die by which the tapered portion 3 is mold cut. A partially overlapped part becomes a seam.

Further, a lower edge of the fan-shaped paper material including a coating layer is bent inward by press working, so that the second tapered portion 11 is formed. An upper side of the fan-shaped paper material including a coating layer becomes the curl portion 9 or the peripheral wall surrounding the top lid portion 2, which will be described later.

The fan-shaped paper material including a coating layer, of which the processing has been completed in the first processing station 61, is transported to a fourth processing station 64. Before describing a process in the fourth processing station 64, a method for producing the top lid portion 2 will be described.

A raw material 60 is a paper material including a coating layer, and is used to form the top lid portion 2. As illustrated in FIG. 29, an upper end and a lower end of the raw material 60 have a wavy shape. Hereinafter, the wavy shape will be described.

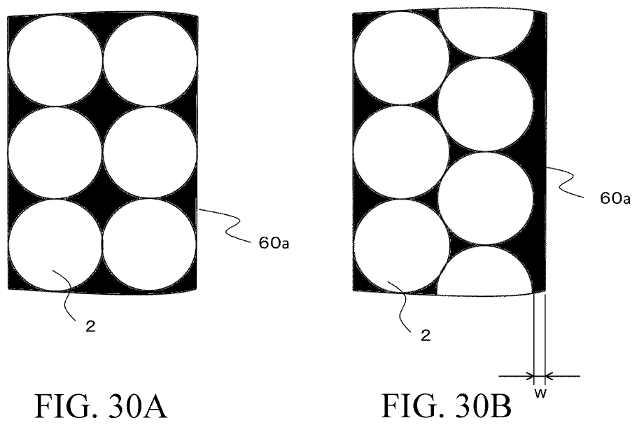

FIGS. 30A and 30B are views illustrating a method for extracting the top lid portion 2 from a raw material 60a. Here, two rows of the top lid portions 2 are extracted from the raw material 60a. As illustrated in FIG. 30A, when a first row of the top lid portions 2 and a second row of the top lid portions 2 of which the positions in the upward and downward direction are the same are extracted, a blackened part is discarded after the top lid portions 2 are extracted.

On the other hand, as illustrated in FIG. 30B, when the first row of the top lid portions 2 and the second row of the top lid portions 2 of which the positions in the upward and downward direction are offset from each other are extracted, a blackened part to be discarded is reduced. Furthermore, because a width w of the raw material 60a is not used, the width of the raw material 60a can be reduced by the width w, and the raw material 60a can be efficiently used. Thereby, it is possible to reduce the production cost of the paper lid 1. Incidentally, it is preferable that the amount of offset between the first row and the second row of the top lid portions 2 in the upward and downward direction is approximately a half the radius of the top lid portion 2. In FIGS. 30A and 30B, the two rows of the top lid portions 2 are extracted from the raw material 60a; however, three or more rows of the top lid portions 2 may be extracted according to the width of the raw material 60a.

In the present embodiment, because three or more rows of the top lid portions 2 are extracted from one sheet of the raw material 60a by the method in FIG. 30B, an upper end and a lower end of a raw material for one row (raw material 60 illustrated in FIG. 29) have a wavy shape. However, at least one of the upper end or the lower end may have a linear shape. For example, when two rows of the top lid portions 2 are extracted from one sheet of the raw material 60a by the method as shown in FIG. 30B, the upper end or the lower end of the raw material 60 has a linear shape. In addition, the raw material 60a of FIG. 30A may be used, and also in this case, one of the upper end or the lower end has a wavy shape, and the other of the upper end or the lower end has a linear shape. Incidentally, when the raw material 60a of FIG. 30A is a raw material from which one row of the top lid portions 2 is extracted, both of an upper end and a lower end of the raw material have a linear shape, and such a raw material may be used.

Returning to FIG. 29, the raw material 60 is transported to a second processing station 62. In the second processing station 62, the seal portions 8 illustrated in FIGS. 23A-23C are joined to the raw material 60. In the second processing station 62, two seal portions 8 are illustrated as being joined; however, the number of the seal portions 8 may be one or may be three or more. The seal portion 8 is transported from a raw material for a seal (not illustrated), a release paper for protection is removed in the process of transportation of the seal portion 8, and an adhesive surface of the seal portion 8 is joined to the raw material 60. A release paper that is different from the release paper for protection may be provided in a part in FIG. 29 to which the adhesive 14 adheres, and the adhesive force of the adhesive 14 may be weaker than the adhesive force of the adhesive 13.

The raw material 60 to which the seal portions 8 are joined is transported to a third processing station 63. In the third processing station 63, a process of forming the drinking spout 5 is performed using a cutting tool. In addition, in the third processing station 63, the extraction of the top lid portion 2 is performed using the cutting tool. The drinking spout 5 is processed while using the seal portion 8, which is joined to the raw material 60, as a marker.

The top lid portion 2 is extracted as indicated by a circular dotted line. In addition, the outer periphery of the top lid portion 2 is bent by press working such that the top lid portion 2 is joined between the tapered portion 3 having a U-shaped cross-section and the second tapered portion 11 (step S3). Either of the processing of the drinking spout 5 and the extraction of the top lid portion 2 may be preferentially performed, or both may be performed at the same time.

The layout may be modified to exchange the position of the second processing station 62 and the position of the third processing station 63, and the process in the third processing station 63 may be performed prior to the process in the second processing station 62. In this case, the seal portion 8 is joined to the top lid portion 2 while using the drinking spout 5 as a marker.

In the present embodiment, the top lid portion 2 of which the processing has been completed at the third processing station 63 is transported to the fourth processing station 64.

In the fourth processing station 64, the top lid portion 2 of which the outer periphery is bent by press working is fitted between the tapered portion 3 having a U-shaped cross-section and the second tapered portion 11. A heat treatment is performed in a state where the top lid portion 2 is fitted between the tapered portion 3 and the second tapered portion 11 (step S4). The films with which the top lid portion 2, the tapered portion 3, and the second tapered portion 11 are coated are melt by the heat treatment, so that the top lid portion 2, the tapered portion 3, and the second tapered portion 11 are jointed to each other by heat sealing. The joining of the top lid portion 2, the tapered portion 3, and the second tapered portion 11 by heat sealing may be performed over the entire surfaces thereof or may be partially performed. For example, the joining of the tapered portion 3 and the second tapered portion 11 by heat sealing may not be performed in the vicinity of the protruding portion 37.

In addition, the peripheral wall surrounding the top lid portion 2 is formed by the tapered portion 3. In the above description, in step S2, the lower edge of the fan-shaped paper material including a coating layer is subjected to press working to form the second tapered portion 11, and in step S3, the outer periphery of the top lid portion 2 is bent by press working. However, the present invention is not limited thereto. For example, immediately before the heat treatment in step S4 is performed or while the heat treatment is performed, at least one of the foregoing press workings may be performed.

When the top lid portion 2, the tapered portion 3, and the second tapered portion 11 are joined to each other by heat sealing, it is preferable that the drinking spout 5 is away from the seam formed in the tapered portion 3 (also referred to as the peripheral wall surrounding the top lid portion). For this reason, it is desirable that a mark provided in the seam or in the vicinity of the seam is detected by an unillustrated detection device and, based on a detection result, the top lid portion 2 may be rotated to adjust the position of the drinking spout 5 before the foregoing heat sealing is performed.

The drinking spout 5 may be formed after the top lid portion 2 is joined to the tapered portion 3 and the second tapered portion 11. The seal portion 8 may be formed subsequent to the formation of the drinking spout 5, or the seal portion 8 may be formed in a later step.

The inner peripheral surface of the second tapered portion 11 is pressed by a piece member of which a part is recessed, so that a part of the second tapered portion 11 that is not pressed by the recessed part of the piece member is formed as the protruding portion 37 (step S5). The protruding portion 37 is formed in an upper end portion of the second tapered portion 11, and the position of the protruding portion 37 in the height direction can be appropriately adjusted by the shape of the piece member. In addition, the height of the protruding portion 37 can be adjusted by adjusting the pressure under which pressing the piece member is performed. The height of the protruding portion 37 may be adjusted by the basis weight of the second tapered portion 11.

In a case where, after the inner peripheral surface of the second tapered portion 11 is pressed by the piece member, the dimension of the inner diameter of the tip (bottom lid portion 4 side) of the second tapered portion 11 is the same as or slightly smaller than that of the outer diameter of the curl portion 22, the curl portion 22 is collapsed (deformed) when the paper lid is fitted to the container 20, so that the paper lid 1 and the container 20 are fitted to each other. Therefore, it is possible to improve the sealability between the paper lid 1 and the container 20. Instead of the foregoing manner or in conjunction therewith, the inner diameter of the tip of the protruding portion 37 that the curl portion 22 enters may be set to be smaller than the outer diameter of the curl portion 22. Accordingly, at least one of the curl portion 22 or the protruding portion 37 is deformed to allow the curl portion 22 and the protruding portion 37 to be fitted to each other. Thereby, it is possible to improve the sealability between the paper lid 1 and the container 20.

After the protruding portion 37 is formed, the top lid portion 2, the tapered portion 3, and the second tapered portion 11, which are joined to each other by heat sealing, are transported to a fifth processing station 65.

In the fifth processing station 65, the curl portion 9 is formed by the curl molding die 70 illustrated in FIG. 11 (step S6). Accordingly, the paper lid 1 of FIG. 27A can be produced. The foregoing production method is one example, and a modification such as exchanging the orders of some steps can be made thereto.

In addition, because the raw material 60 is a paper material including a coating layer as described above, when the window portion 18 illustrated in FIGS. 16A-16C and FIGS. 21A and 21B is to be formed, it is preferable that an opening of the window portion 18 is formed before the coating layer, such as a film, is joined to the paper material. When the paper material and the film are joined to each other, the paper material and the film may be laminated together or may be T-die molded. When the paper material and the film are joined to each other by heating, the dimensions of the film are prone to change in a process where the temperature returns to a normal temperature or a room temperature. For this reason, a step of cooling the paper material and the film that are joined to each other may be provided. Alternatively, a raw material in which the window portion 18 is formed may be used as the raw material 60. Accordingly, even when a cooling step is not provided, because a sufficient time can be taken until the process is performed in the second processing station 62, it is possible to reduce a change in the dimensions of the film.

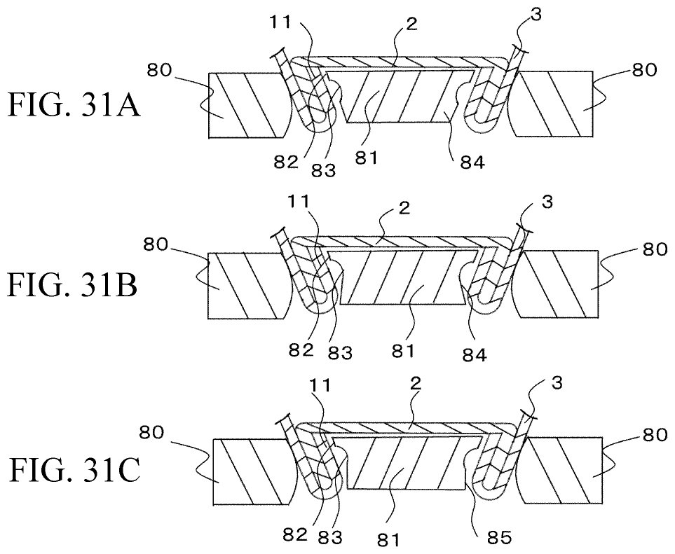

Examples where the protruding portion 37 of FIG. 22A, the protruding portion 37 of FIG. 27C, and the protruding portion 37 of FIG. 27D are formed using the piece member will be next described. FIGS. 31A-31C are cross-sectional views of a forming device that forms the protruding portion 37. In FIGS. 31A-31C, three examples of the forming device are illustrated. Hereinafter, descriptions will be given in order, with duplicate descriptions omitted. The forming device can be provided in the fourth processing station 64.

FIG. 31A illustrates the forming device that forms the protruding portion 37 of FIG. 22A. The forming device includes a fixing member 80 that fixes the tapered portion 3 having a U-shaped cross-section from outside, and a piece member 81 made of metal. The piece member 81 has, on the whole, a circular shape or an oval shape, and includes an upper tapered portion 82 having the same tapered shape as that of the second tapered portion 11, a barbed portion 83 that forms the protruding portion 37, and a lower tapered portion 84 having the same tapered shape as that of the second tapered portion 11.

Here, it is assumed that the top lid portion 2 is already joined to the tapered portion 3 having a U-shaped cross-section. In a state where the tapered portion 3 having a U-shaped cross-section is fixed by the fixing member 80, the piece member 81 is eccentrically rotated by an unillustrated driving mechanism to cause the upper tapered portion 82 and the lower tapered portion 84 to press the inner periphery of the second tapered portion 11, so that the protruding portion 37 of FIG. 22A can be formed.

FIG. 31B illustrates the forming device that forms the protruding portion 37 and the weak tapered portion 11b of FIG. 22C. The taper angle of the lower tapered portion 84 is different from the taper angle of the second tapered portion 11. The weak tapered portion 11b can be formed by pressing the inner periphery of the second tapered portion 11 with the lower tapered portion 84 having a taper angle different from the taper angle of the second tapered portion 11.

FIG. 31C illustrates the forming device that forms the protruding portion 37 and the linear portion 11c of FIG. 22D. Instead of the lower tapered portion 84, a linear portion 85 is provided. The linear portion 11c can be formed by pressing the inner periphery of the second tapered portion 11 with the linear portion 85.

Heat Retention

In regards to an improvement in the heat retention of the content in the container 20, other effects can be obtained by the paper lid 1. Hereinafter, an improvement in heat retention obtained by the paper lid 1 of the fifth embodiment will be described.

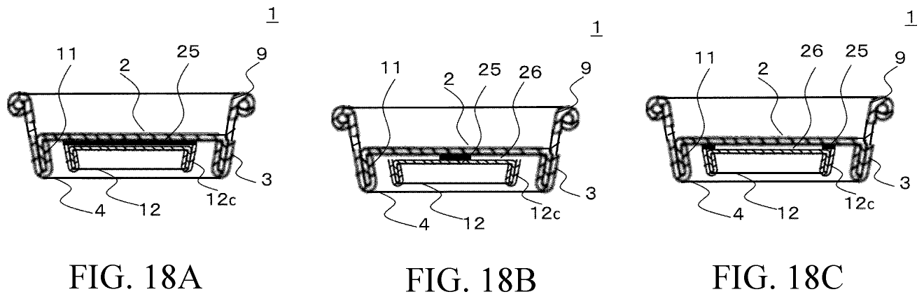

FIGS. 18A-18C are views illustrating an example of the joining of the top lid portion 2 of the paper lid 1 and the engaging portion 12 in FIG. 9A. FIG. 18A is an example of a joining where an adhesive 25 is applied to the entire surfaces of the top lid portion 2 and the top lid portion 2a (see FIGS. 10A-10C) of the engaging portion 12 to bond the top lid portion 2 and the engaging portion 12. A space portion 26 is not present between the top lid portion 2 and the top lid portion 2a. FIG. 18B is an example of a joining where the adhesive 25 is applied to central portions of the top lid portion 2 and the top lid portion 2a (see FIGS. 10A-10C) of the engaging portion 12 to bond the top lid portion 2 and the engaging portion 12, and the space portion 26 is present. FIG. 18C is an example of a joining where an adhesive 25 is applied to outer peripheries of the top lid portion 2 and the top lid portion 2a (see FIGS. 10A-10C) of the engaging portion 12 to bond the top lid portion 2 and the engaging portion 12, and the space portion 26 is present.

In a state where 150 cc of water (content) at 75° C. was put in the 5 oz container 20 and the paper lid 1 was fitted to the container 20, a heat retention test was carried out to measure the temperature of the water per elapsed time. In addition, tests were performed in two types of states such as a state where the drinking spout 5 was closed and a state where the drinking spout 5 was open.

In addition, as a comparative example, the tests were performed also on a plastic lid in current use. Because the plastic lid is not a type of lid where the top lid portion 2 and the engaging portion 12 are joined to each other, a bonding part is not present.

TABLE 1

| | Bonding | Elapsed time (minutes) | | | | | | |
|---|---|---|---|---|---|---|---|---|
| State of lid | method | 0 | 10 | 20 | 30 | 40 | 50 | 60 |
| Drinking | Entire | 75 | 57 | 51 | 45 | 42 | 39 | 37 |
| spout is | surface | | | | | | | |
| open | bonding | | | | | | | |
| | Central | 75 | 58 | 52 | 46 | 43 | 40 | 38 |
| | bonding | | | | | | | |
| | Outer | 75 | 58 | 52 | 46 | 43 | 40 | 38 |
| | peripheral | | | | | | | |
| | bonding | | | | | | | |
| | Comparative | 75 | 57 | 51 | 46 | 42 | 39 | 37 |
| | Example | | | | | | | |
| Drinking | Entire | 75 | 57 | 52 | 47 | 44 | 41 | 38 |
| spout is | surface | | | | | | | |
| closed | bonding | | | | | | | |
| | Central | 75 | 58 | 52 | 48 | 44 | 41 | 39 |
| | bonding | | | | | | | |
| | Outer | 75 | 58 | 52 | 48 | 44 | 41 | 39 |
| | peripheral | | | | | | | |
| | bonding | | | | | | | |
| | Comparative | 75 | 57 | 51 | 47 | 43 | 40 | 37 |
| | Example | | | | | | | |

As shown in Table 1, the heat retention of the paper lid 1 is not inferior to that of the plastic lid in current use, and in a measurement in the example where the adhesive 25 is applied to the central portions and a measurement in the example where the adhesive 25 is applied to the outer peripheries, the heat retention is better by 1° C. to 2° C. than that of the plastic lid. This is due to the heat insulating effect of the space portion 26. The heat retention effect of the paper lid 1, which is environmentally friendly, was confirmed. Incidentally, the joining of the top lid portion 2 and the engaging portion 12 is not limited to bonding, and so long as the space portion 26 can be formed, any joining method may be used.

### Other Modification Examples

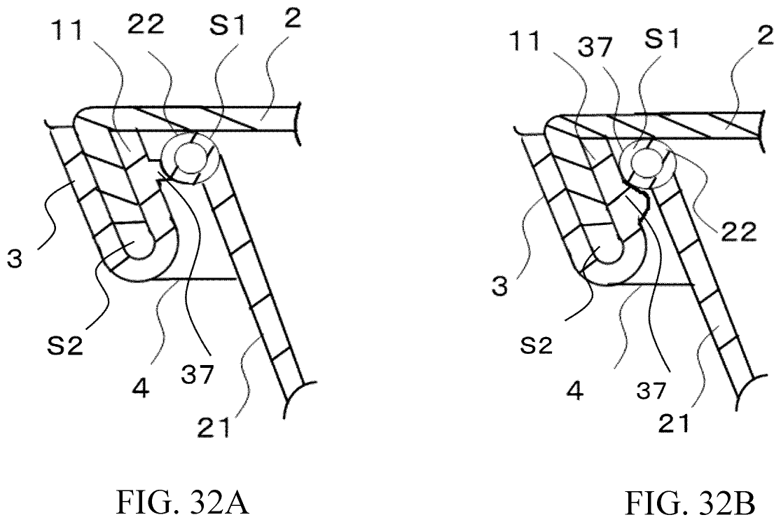

FIGS. 32A and 32B show a modification example of the paper lid 1 of the eighth embodiment illustrated in FIGS. 22A-22G. In FIG. 32A, the protruding portion 37 is shaped to conform to the circumferential shape of the curl portion 22. As described above, where the shape of the protruding portion 37 is a circumferential shape, it is preferable that an upper side of the curl portion 22 is shaped to come into contact with the top lid portion 2.

In FIG. 32B, the shape of the protruding portion 37 conforms to the circumferential shape of the curl portion 22, and a part of the curl portion 22 is held from below.

It is preferable that, as illustrated in FIGS. 32A and 32B, the part of the curl portion 22 is held from below and the upper side of the curl portion 22 is shaped to come into contact with the top lid portion 2. Because the curl portion 22 is interposed (embraced) between the protruding portion 37 and the top lid portion 2, it is possible to further improve the sealability between the paper lid 1 and the container 20. In addition, where the protruding portion 37 is shaped such that the curl portion 22 is interposed (embraced) between the protruding portion 37 and the top lid portion 2, it is possible to reduce the amount of deformation of the curl portion 22. Accordingly, even when the paper lid 1 is repeatedly fitted to or removed from the container 20, it is possible to inhibit a deterioration in sealability between the paper lid 1 and the container 20.

Where the content of the container 20 is a hot beverage, there is a risk that the protruding portion 37 is deformed due to steam or heat or the protruding portion 37 and the curl portion 22 slide on each other to cause a deterioration in sealability between the paper lid 1 and the container 20. However, where the protruding portion 37 is shaped to support a lower side of the curl portion 22, the influence when the protruding portion 37 is deformed is small, and the influence when the protruding portion 37 and the curl portion 22 slide on each other is also small. So long as the protruding portion 37 is shaped to support the curl portion 22, the protruding portion 37 may have a tapered shape, or a plurality of the protruding portions 37 may support the curl portion 22.

In addition, the top lid portion 2 of which the outer periphery is bent by press working is fitted between the tapered portion 3 having a U-shaped cross-section and the second tapered portion 11. However, the dimensions of the bent part are shortened to form a space S2. As described above, because the dimensions of the bent part are shortened, it is possible to reduce the amount of the paper material used to produce the top lid portion 2. In addition, because the rigidities of the tapered portion 3 having a U-shaped cross-section and the second tapered portion 11 can be reduced by the space portion S2, the curl portion 22 easily enters the paper lid 1.

Also in the modification example of FIGS. 32A and 32B, the weak tapered portion 11b illustrated in FIGS. 27B and 27C may be provided and the linear portion 11c illustrated in FIGS. 27D and 27E may be provided.

Where the sealability between the paper lid 1 and the container 20 can be secured by the protruding portion 37, the tapered portion 3 and the second tapered portion 11 may have a linear shape. Also in this case, as illustrated in FIG. 22A, the height H2 of the peripheral wall may be set to be from approximately 36% to 48% of the entire height H1; and thereby, a plurality of the paper lids 1 can be easily stacked.

The foregoing embodiments are exemplary embodiments. However, the present invention is not limited to the foregoing embodiments, and the foregoing embodiments may be appropriately combined, or a part of the configurations may be omitted. In addition, the configurations may be partially modified. For example, a cut may be provided in the curl portion 9 to weaken the rigidity of the curl portion 9. The container 20 using the curl portion 9 provided with the cut may be fitted from outside. Further, a technique where a part of the press machine is heated when press working is performed has been disclosed, and also when ultrasonic joining is performed, a part (for example, a part holding the paper lid 1) of an ultrasonic joining device may be heated to approximately 50° C. to 85° C. As described above, because the paper lid 1 is produced while being subjected to heat, even when the content of the container 20 is a hot beverage (60° C. to 100° C.), the paper lid 1 is less likely to be deformed to the shape before press working; and thereby, it is possible to reduce the risk that the paper lid 1 is removed from the container 20.

At least one member of the engaging portion 12, the base portion 12a, the engaging part 12b, the curl portion 29, or the engaging portion 36 may be made of an air-laid material where crushed pulps are laminated together. In this case, the basis weight of the air-laid material is from 20 g/m² to 100 g/m², preferably from 40 g/m² to 60 g/m². In addition, it is desirable that films (for example, polyethylene films) are laminated on both surfaces of the air-laid material and are joined thereto by ultrasonic joining. Because air-laid material is used, the air-laid material is capable of serving as a cushioning member or a packing.

The paper lid 1 of the present embodiment may be used as a lid for a food such as a confection, or may be used as a lid of a wet tissue package accommodating wet tissues.

As described above, various modifications can be made without departing from the concept of the present invention.

The following is a list of reference numerals used in the specification.
1 PAPER LID
2 TOP LID PORTION
3 TAPERED PORTION
5 DRINKING SPOUT
6 GROOVE PORTION
8 SEAL PORTION
9 CURL PORTION
10 MARK
20 CONTAINER
21 TAPERED PORTION
22 CURL PORTION
30 HOLDER
31 HINGE

What is claimed is:

1. A paper lid comprising:
a lid body portion that includes a paper material and is to be mounted on a container, the container including an opening portion, a taper, and a curl portion;
a top lid portion having an outer periphery surrounded by the lid body portion; and
an engaging portion that is provided in the lid body portion, includes a tapered portion tapering in the same direction as a direction of the taper of the container, and engages with the curl portion of the container from an outside of the curl portion of the container,
wherein the lid body portion has a first end portion to be mounted on the container and a second end portion opposite the first end portion, and
wherein the outer periphery of the top lid portion is bent toward the first end portion, and a bent portion of the outer periphery of the top lid portion is bonded to the lid body portion,
wherein a part other than the outer periphery of the top lid portion is located between the engaging portion and the second end portion,
wherein a dimension of an inner diameter of a tip of the tapered portion is smaller than a dimension of an outer diameter of the curl portion of the container,
wherein in a state where the paper lid closes the opening portion of the container, the curl portion of the container is in contact with a tapered part that is an inner part of the tapered portion of the engaging portion.
